(19) United States
(12) Patent Application Publication
(10) Pub. No.: US 2019/0043148 A1
(43) Pub. Date: Feb. 7, 2019

(54) INFORMATION COLLECTION USING MULTIPLE DEVICES

(71) Applicant: The Government of the United States of America, as represented by the Secretary of Homeland Security, Washington, DC (US)

(72) Inventor: Arun Vemury, North Bethesda, MD (US)

(73) Assignee: The Government of the United States of America, as represented by the Secretary of Homeland Security, Washington, DC (US)

(21) Appl. No.: 16/150,690

(22) Filed: Oct. 3, 2018

Related U.S. Application Data
(63) Continuation-in-part of application No. 15/223,172, filed on Jul. 29, 2016.
(60) Provisional application No. 62/198,776, filed on Jul. 30, 2015.
(60) Provisional application No. 62/221,436, filed on Sep. 21, 2015.

(51) Int. Cl. G06Q 50/26; G06F 17/30; G06K 19/06

(52) U.S. Cl. CPC G06Q 50/265; G06K 19/06037; G06F 17/30312

(57) ABSTRACT

Embodiments are described in which information from multiple devices is merged through the exchange of linking information. For example, a two dimensional barcode is used associate information originating from different devices. In embodiments, information is associated with various levels of trust based on a variety of factors to quantify whether or not and to what extent collected information can be relied upon to be accurate. In embodiments, information from multiple sources is merged into a common transaction record that can be accessed through use of the linking information so the information can be efficiently retrieved even though it originated, or was captured, by different devices.

### CROSS-REFERENCE

This application is a continuation-in-part, in accordance with 35 U.S.C. § 120, and claims priority to U.S. patent application Ser. No. 15/223,172, filed Jul. 29, 2016, entitled Identity Verification System and Method, published as U.S. Published Patent Application 20170032485, which claims priority, respectively, to U.S. Provisional Patent Application No. 62/198,776, filed Jul. 30, 2015, entitled Identity Verification System and Method and U.S. Provisional Patent Application No. 62/221,436 filed Sep. 21, 2015, entitled Identity Verification System and Method each of the foregoing is hereby incorporated by reference in its entirety.

### GOVERNMENT RIGHTS

This invention was made with United States Government support. The Government has certain rights in this invention.

### FIELD OF THE DISCLOSURE

This application generally relates to electronically merging information from multiple devices. Embodiments are described in which computing systems merge information from trusted and untrusted devices. In specific embodiments, systems in accordance with this disclosure merge user supplied information collected from an untrusted or semi-trusted device (e.g., a mobile device) with information from a trusted device. This disclosure describes embodiments in which information from a trusted touchpoint (e.g., a kiosk) is merged with information supplied by a mobile device. In additional embodiments, the systems, devices, methods of the present disclosure implement a temporal or positional constraint on information provided for merging by one or more of the trusted or non-trusted device.

### BACKGROUND

Data handling from multiple computing devices is problematic. This is particularly evident in time-constrained environments. Unlike situations in which time is not a significant issue, some situations greatly benefit from efficient data handling. One example of this are screening processes, such as those at a port-of-entry or security check points for mass transit. These environments are complex because large numbers of people from diverse backgrounds, education and familiarity with technology and screening processes are screened on a regular basis. In these environments, efficiency and security are of prime concern. For example, even a minor delay with one traveler can cascade into a macro delay involving multiple travelers. These delays often result in operational inefficiency, e.g., personnel focusing time/attention on individuals with technology issues instead of other issues. Take for example a U.S. Customs and Border Patrol port of entry or a Transportation Safety Administration check point, both of which implement a combination of equipment (e.g., scanners) and personnel to screen people and associated items. While these examples are discussed throughout this document, the described apparatuses, devices, techniques, systems, and approaches are applicable to other environments.

### SUMMARY

Collection, validation, accuracy checking, and matching of information for individuals, e.g., in-scope people entering/exiting a country, is described. The systems, techniques, devices, methods, and approaches described herein can be used to collect biographic, biometric, and travel information for persons.

In an embodiment, biographic and/or travel information and biometric information are merged responsive to receipt of linking information. The merged information is stored in a record of a transaction. An electronic receipt for the transaction is generated, including machine-readable information usable to retrieve at least a portion of the merged information from the record. At least a portion of the merged information is retrieved responsive to reading the machine readable information output on the untrusted device.

In another embodiment, information is accepted from an untrusted device, responsive to a determination that the untrusted device is within a predetermined physical location. Using machine readable information associated with a trusted device received from the untrusted device, biometric information from the trusted device is merged with information from the untrusted device. An electronic receipt is communicated to the untrusted device, including machine readable information usable to retrieve at least a portion of the merged information, responsive to reading of the machine readable information in the electronic receipt.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The same numbers are used throughout the drawings to reference like features.

FIG. 1 illustrates an operating environment in which the inventive principles can be employed in accordance with one or more embodiments.

FIG. 2 illustrates a predetermined location represented as a local environment that implements a geo location constraint in accordance with one or more embodiments.

FIG. 3 is a flow diagram that describes steps for applying a constraint (e.g., time and/or geo location) that can be used in conjunction with data merging disclosed in this document in accordance with one or more embodiments.

FIG. 4A is a pictorial representation of a mobile device capturing linking information, e.g., a two-dimensional barcode, from a display included in a touchpoint in accordance with one or more embodiments.

FIG. 4B is a pictorial representation of a mobile device capturing linking information, e.g., a two-dimensional barcode, affixed to a touchpoint in accordance with one or more embodiments.

FIGS. 5A-5C illustrate sample data flows in conjunction with hardware/software in accordance with this disclosure. Example hardware/software is disclosed, the steps, methods, approaches, and techniques are not restricted to the illustrated hardware/software.

FIG. 6 illustrates an example configuration of resources including third-party resources that can be implemented in conjunction with the devices, systems, methods, approaches, and techniques disclosed in this document.

### DETAILED DESCRIPTION

Overview

Merging data from multiple devices poses technical challenges. In particular, merging data from multiple devices, including untrusted devices, in a time constrained environment poses a unique technical challenge as the technology should keep pace with its environment or overall process in which it is utilized. For example, electronically associating information, such as biographic and biometric information, with an identity is important in a variety of situations and raises technological challenges as the individual is often required to be present in a predetermined location during screening. Matching an individual exiting a country to his or her record is important because it is the last time at which the individual is physically within the jurisdiction. While correct identification and screening are important, time is of concern compared to for example a routine business calculation occurring at the end of a work day.

Because entities performing identification often do not control or only partially control when individuals present themselves for identification, technology is important to identification and screening environments. As a result, the systems, devices, methods and approaches should be dynamically scalable to address different volumes of individuals such as, students entering a test location, customers arriving at a department of motor vehicles, travelers arriving at an airport or port-of-entry. This can be additionally challenging as resources are often sized for the average anticipated throughput, not for the greatest anticipated throughput or unanticipated surges.

Border screening environments experience technological challenges as large numbers of individuals can arrive unexpectedly. Monday mornings and Friday evenings, for example, are times at which airports experience a large influx of individuals beyond that which is anticipated for these times. There are instances in which deployed resources (equipment, personnel) are not within pre-established tolerances in comparison to the demand. In some instances, it is impractical to deploy additional resources to meet an influx of people sufficient to improve user experience, e.g., maintain an average wait time below a tolerance for a given timeframe. In these instances, the average wait time increases or the configuration/operation of the system is dynamically altered to maintain the average wait time within predefined tolerance.

The system, devices, approaches, and procedures of the present disclosure can merge information from multiple devices to, among other benefits, improve user experience and decrease wait times. Merging information in such instances presents a unique challenge as the number of individuals and their data can vary greatly due to a wide variety of factors. Example factors include weather, technology, cultural norms, overall procedure factors (e.g., security level), and so forth.

Situations such as these may involve electronically collecting, reviewing, merging, recording and/or storing different types of information and in some instances information from different devices/computing resources associated with different levels of trust, e.g., trusted, substantially fully-trusted, substantially non-trusted, and not trusted.

In a border control environment, this can include collecting biometric and biographic information (which may include travel information) and merging the information into a record for the transaction. In the immediately preceding example, a trusted device provides the biometric information, while the non-trusted device is used to provide biographic/travel information, although other scenarios are contemplated.

Additional information can be merged or otherwise interrelated with the information, e.g., form metadata to the merged information. In embodiments, a record for a transaction is interrelated with records of other transactions based on a unique identifier, name, a digital signature, location, time, responsible officer, a flag, item, and/or the like. The information can be used by a system or device for other purposes. For example, information that results in a match, but only to an “acceptable” threshold is also retained in a separate gallery to be used as a basis for exclusion.

In embodiments, the systems, devices, and processes disclosed in this document merge information for a transaction (e.g., biographic information, information, travel information, biometric information) and associate the merged information with an identity. In additional examples, the information is retained as a record with the provided information and additional information. Embodiments are described in which devices exchange linking information so information from different resources can be merged automatically, e.g., without human intervention. The foregoing may be done for use in screening, recordkeeping, and the like and may be accomplished in situations in which some of the components/devices are not trusted or are only trusted to a particular level that is either pre-established or dynamically established.

Optionally, the devices, systems, and methods of this disclosure electronically compare the identity to information in a reference library to validate that the identity is known (e.g., a valid identity) to a predetermined threshold, or that the identity in question is excluded (such as from a watch/wanted list or registry, or simply an imposter (e.g., non-match)) to a predetermined threshold.

For example, a computing system implementing a facial recognition algorithm compares information from an obtained facial image (e.g., a hash or signature) with information from an image or a gallery of images that are predetermined to be associated with an individual to which the obtained image information is to be matched. In a generally similar fashion, a system may compare information from one or more obtained images in order to confirm the information for the individual does not match information for an individual that is excluded, e.g., on a no-fly list, a wanted individual, a non-defined impostor, or a barred from entry list. These comparisons can be done in a variety of ways, for example obtained information or information derived from the obtained information is checked against reference information, or a portion thereof, for the excluded individual to determine if the obtained and reference information match or match to some predetermined threshold or do not match, e.g., are excluded. An example of this is comparing preselected data points with corresponding preselected data points for the reference, such as in a key-point recognition method for fingerprints.

The threshold applied to the information may vary based on timeframe, location, algorithm efficiency, random application (e.g., based on a computer implemented algorithm that attempts to randomize what threshold it applies), based on a characteristic of the individual or a characteristic associated with the individual being screened (e.g., recently obtained a passport), based on one or more characteristics of one or more individuals being excluded, and so forth. An output of the identification can be included in the merged information even though in some instances the output is added subsequent to a point in time at which a system merges collected biometric and biographic information. In further instances, the information is provisionally merged and held, for example, in memory used to store information in a transitory manner before being included in a formal record. This may be done for computing reasons (communication availability, processing resources, etc.) or for operational, e.g., safety concerns. An example of the latter is locking or flagging a stored record to prevent the information in that record being used as a basis of comparison or being updated until the occurrence of an event, e.g., the record is released by a local resource after occurrence of an anticipated transaction.

In an embodiment, subsequent to a computing system merging biometric and biographic information (which can include travel information) from more than one or multiple physical or logical devices, the computing system stores the output of the identification or exclusion evaluation in association with the biometric and biographic information that forms the merged data. In another instance, a hash of an electronic fingerprint scan for an individual being identified is created using a computer implemented algorithm that identifies data points that, compared to other data in the scan, are highly relevant to identification. The result of the hash is then compared to one or more hashes of fingerprints (or in some cases by applying the hash to data for reference fingerprints) to establish the identity of the individual by matching the data from the hash to that in the library or that derived from information in the library, e.g., the algorithm is applied to data in a file representing the fingerprint to a predetermined threshold match level. The output of the hash comparison can be stored in conjunction with the merged data.

Identification in some instances involves comparing obtained biometric information, such as the features of the individual represented by data points, with the features (also represented as data points, e.g., data points obtained by application of an identification algorithm to the features in question) associated with a reference, like a token, such as an identification document (e.g., driver's license, an electronic driver's license, passport, permanent resident card) or by accessing a resource, e.g., a student directory with a gallery of images and biographic information. In instances such as this, a device/system may capture an image of the token and/or electronic information obtained from electronic media included in the token (e.g., traveler information, such a facial image, stored on a computer chip included in an e-passport), and include it in the merged information or store it in conjunction with the merged data.

Embodiments are disclosed in which the example systems, devices, methods, and approaches merge or otherwise interconnect information associated with the device with the merged information. For example, a system operating in conformance with the present disclosure stores one or more of the following information related to a user's mobile device: a unique identifier (e.g., SIM card), device model number, software version, operating configuration, and so forth.

In additional embodiments, systems, devices, methods, and approaches in accordance with this disclosure constrain one or more of obtaining, providing, or merging of data. Example constraints include a temporal (time) constraint, a geographic/location constraint, or a combination thereof. In some embodiments, a local device (operating independently or as part of a system) implements one constraint and another component or portion of the system implements an other constraint which may be the same or different than that implemented by the device. For example, a mobile device implements a temporal constraint that prohibits the collection or communication of information to a central resource before a window of time designated by the central resource or another component in a system including the central resource. In the previous example, the central resource implements a geographic constraint that excludes receipt of information unless the mobile device sending the information is within a predetermined geographic location.

Although this application discloses embodiments, implementations, and scenarios involving customs and travel records management, it should be understood that the principles of the present disclosure are applicable to a wide variety of situations and environments. The techniques, approaches, software, firmware, and/or hardware described herein may be utilized where information is managed, collected, exchanged, vetted, or otherwise compared. Other situations that can benefit from this technology include, but are not limited to, customer check-ins, vehicle registrations, driver license registrations, permit collection (e.g., building permits), identification of individuals, correctional institutions settings, massive data systems (whether containing biometric and/or biographic data), and the like. In situations, the techniques, approaches, concepts, software, firmware, and hardware described herein are implemented to obtain, merge, identify, store, check, verify, authenticate, and match information for individuals.

In the discussion that follows, a section entitled “Operating Environment” describes but one environment in which the various embodiments can be employed. Following this, an “Example Methods” section describes how accurate information matching to ensure accurate recordkeeping can be achieved. While the systems, hardware, software, techniques, methods, and approaches are described in relationship to particular implementations, the underlying principles disclosed herein can be combined, adjusted, or manipulated. The hardware described herein can be used in conjunction with the disclosed methods, processes, and approaches and vice versa, although neither should be considered as limiting the other to a particular mode of operation, configuration, or schema.

Before discussing example operating environments, a brief discussion of the relevance of trust is discussed with respect to the systems, devices, components, methods, techniques, and approaches to give an appreciation how aspects of the present disclosure including the merging of information can be associated with confidence placed in the device, component, or step providing reliable/accurate information. In embodiments, algorithms implemented as computer executable instructions are used to gauge a level of trust associated with the device, component, or information based on one or more predetermined factors. In some embodiments, previously collected information is used as a basis for predicting or analyzing the level of trust assigned or otherwise associated with the item or information. Predictive analytic software (embodied in memory or tangible non-transitory media) can be used by a resource to make such a determination.

In embodiments, some components or devices included in a system are fully trusted, trusted, substantially trusted, and so on, indicating that the security/integrity of the device is generally equivalent to that of the system. Example trusted devices may be trusted or not trusted due to a predetermined status, e.g., it is owned, operated, maintained, or certified by an entity operating the system, by an entity that has a legal obligation to ensure the security or integrity of the device to the entity operating the system, or the like. In other instances, a device is trusted if it: conforms to a standard; meets one or more predetermined criteria; or lacks components including hardware or software, or lacks a vulnerability whether associated with hardware/software. It will be appreciated that a trust level associated with a resource can extend to the information origination from or communicated by the resource. For example, information from a smartphone that exhibits good cyber hygiene is “trusted” in comparison to information from other smartphones that do not exhibit as good cyber hygiene relative to the smartphone.

A device and its associated information may be deemed “trusted” based on a certification process that verifies the device's state (and any updates whether hardware or software) meets one or more predetermined criterion. Generally, a device or component status as being untrusted, substantially untrusted, and/or partially untrusted can be based on the same or substantially the same factors as those for trusted devices/components. For example, a smartphone can be treated as untrusted. The smartphone may be untrusted based on a variety of rationale, such as those discussed with respect to trusted device.

In some embodiments, a level of trust or lack of trust is associated with a portion of a component or device. For example, due to a known cyber vulnerability, a global positioning system unit included in a smartphone is associated with a lower level of trust than the overall device or other subcomponents of the device. It is to be appreciated in the previous example that information associated or related to the subcomponent (whether hardware, software, or a combination thereof) may be likewise associated with that trust level. Thus, in the foregoing example, location information is given a lower trust level than other information provided by the device including the subcomponent. Accordingly, a system may implement different procedures based on the trust level associated with the device, subcomponent or information relative to devices, subcomponents, or information having a different trust level.

In some instances, devices such as a “bring your own device” (BYOD) used in or in conjunction with the system can be assigned a default status of for example, “untrusted” until a different trust level can be established. For example, a traveler's smartphone is designated as untrusted until the system establishes a trust level such as through security protocol, e.g., as a handshake-type exchange or inquiry that can be used by the system to ensure the device meets one or more predetermined factors.

Example criterion include one or more criteria associated with the particular device (e.g., hardware, software or a combination thereof), an individual associated with the device (e.g., owner, service provider, user, manufacturer), a predetermined random criterion, and the like. For example, a mobile device (and information from that device) returning from a location that is known for lax cyber security is handled differently than a substantially similar device from a location associated with good cyber security practices.

In another example, based on a computer implemented algorithm, a system applies a higher security threshold than that of another similarly situated device. In a further example, a system checks one or more of the device's operating system configuration, application version, SIM card number (e.g., to determine if the device has previously interacted with the system) by comparing the information provided by the device with one or more of information in a lookup table and or an information resource/database of merged data.

In embodiments, information associated with a device's level of trust (e.g., trust information) is included with the underlying information. For example, biographic information for an individual is associated with metadata indicating a comparatively low level of trust (e.g., a low trust level) because the information was not received from a mobile phone previously used by the individual, such as because the individual lost her smartphone while traveling abroad. In comparison, a similarly situated other individual's biographic information may be assigned a comparatively “high” level of trust because it was provided by a device that also provided biographic information when the other individual left the country. In other embodiments, trust information is included with the underlying information rather than including it as metadata.

Operating Environment

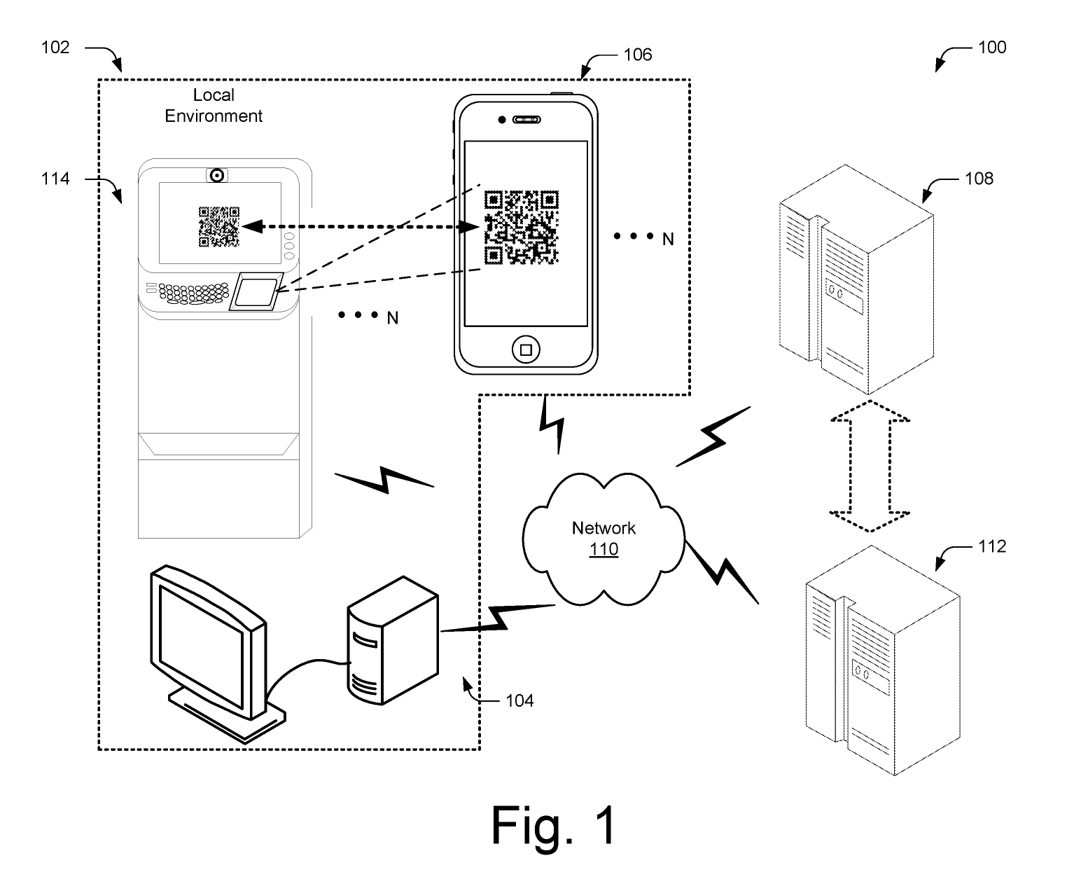

Referring now to FIG. 1, an example environment 100 that can make use of the devices, systems, computer readable instructions, processes, approaches and methods of the present disclosure is described. It is to be appreciated that the principles of this disclosure are described in conjunction with sample environments to aid reader understanding of the described technologies. The environment is not necessarily restrictive of the embodiments disclosed therewith.

As illustrated, the environment 100 includes a predetermined location (illustrated as a local environment 102) including a front end system 104 and one or more mobile devices, illustrated as smartphones 106. A central resource 108 is communicatively coupled to the system components within the predetermined location by a communication network 110. While the central resource is illustrated as being beyond the predetermined location, in some embodiments the central resource can be within the predetermined location or virtualized such as being a cloud resource. The functionality of the front end system and central resource, among other aspects, are capable of being implemented as a cloud-based service.

In addition to the system, external or a third-party 112 resource is illustrated in FIG. 1 as being communicatively coupled to the central resource 108. The third-party resource (shown as a server) is illustrative of functionality/sources of information that are available to the central resource. Third-party resources can be associated with different levels of trust, e.g., trusted, not trusted, partially trusted, trusted with respect to one or more types or kinds of information or the like.

Example third-party resources include computing systems owned, operated, and/or maintained by entities that provide or exchange information with systems in accordance with the present disclosure. Example third-party resources include a flight information system for an airline, a passport database operated by a government of a foreign country, an airport authority flight manifest system, a cargo line information system, a state law enforcement database, a tribal information system, a testing entity, a mobile telephone service provider, and so forth.

In some embodiments, communications between the front end system and the third-party resource occur with the central resource 108 or are routed through the central resource 108 to minimize the risk of unauthorized access or activity. In additional embodiments, a front end system 104 is configured to obtain predetermined types of information, e.g., travel information, driving record, social media information, criminal record information, medical information, and so forth based on design preference. The front end system, touchpoints 114 (one example is illustrated), and central resource may be prohibited from obtaining/receiving/implementing predetermined types of information, sources, and so forth for a variety of reasons, including but not limited to cyber security. For example, the front end 104 includes software that inspects received information for malicious executable code, information types (e.g., image files) or other predetermined types of information corresponding to potential threats. In another example, the front end system 104 is permitted to receive information that has been screened by the central resource 108.

Referring again to FIG. 1, the local environment 102 may be for example a geographic location such as an airport, a testing location, department of motor vehicles, or border checkpoint where one or more individuals present themselves for identification, which may be part of a larger screening process in which merging information is implemented. While one local environment 102 is illustrated, the system may include more than one, or multiple local environments corresponding to predetermined environments and corresponding components and devices associated with the environments. In some embodiments, a predetermined geographic location corresponds to an area designed in an electronic manner, such as through electronic fencing that uses global positioning system (GPS) and/or electronic beacon technology (e.g., wireless beacons), which can be used to define whether a given location of the mobile device, e.g., smartphone, falls within the predetermined geographic location. In some embodiments, a predetermined location corresponds to a building, a space (e.g., a room or area) within a building, an outdoor area bounded by a fence, and the like.

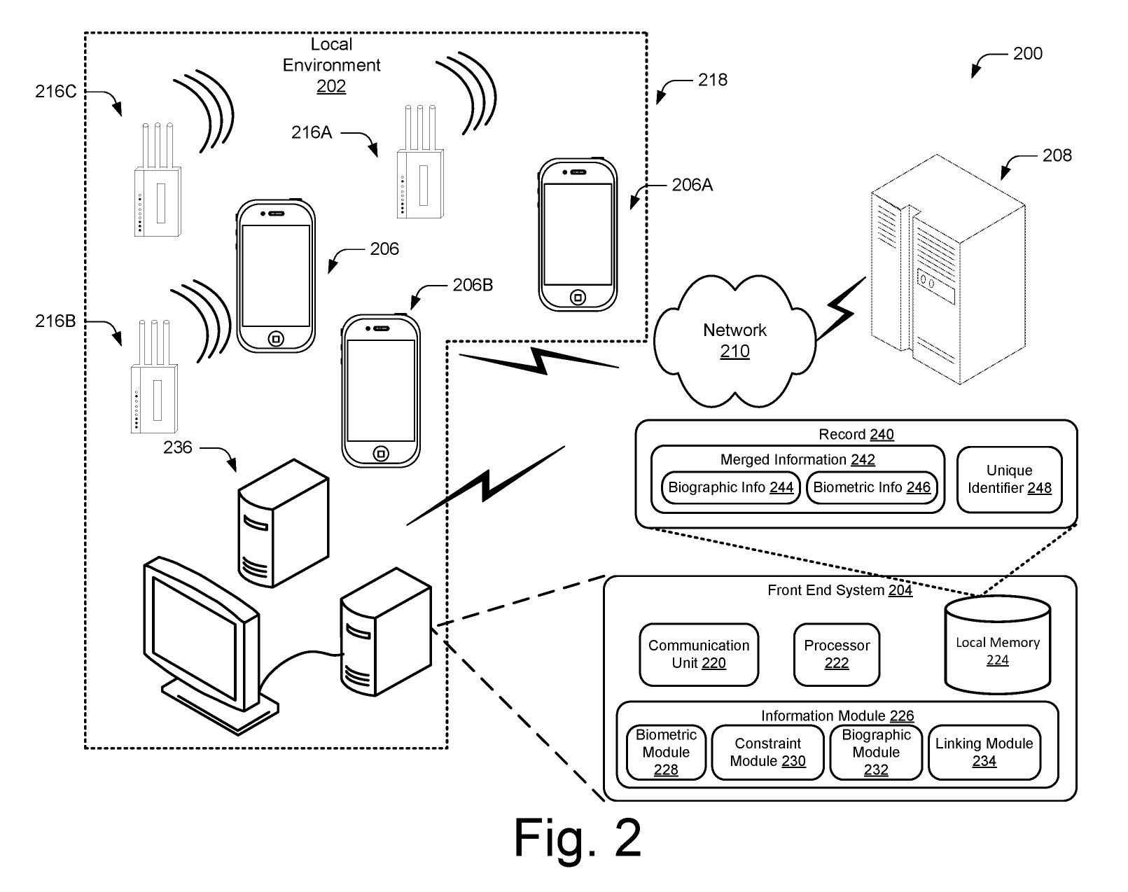

Referring now to FIG. 2, in embodiments, the smartphones (additional smartphones are designated by reference numerals including a terminal letter) are used as a mechanism to implement a constraint such as to geo-locate (geo-fence) an individual/smartphone on the understanding that the individual is in possession of his/her smartphone, e.g., is co-located with the smartphone. In examples, this geo-location is used to constrain an aspect of handling data from multiple sources, e.g., data input, transmission, receipt, time stamping, pre-processing, merging, processing, storing of information, receipt generation, link generation, encryption, receipt transmission, and so forth.

For example, FIG. 2 includes wireless beacons 216A-216C (such as those compatible with 802.11 wireless local area network or BLUETOOTH standards promulgated respectively by the Institute of Electrical and Electronics Engineers (IEEE), New York, N.Y., or (Bluetooth SIG, Kirkland, Wash.) for identifying that a device (a smartphone, tablet, etc.) is within the local environment 202. The beacons 216A-216C can be constructed to provide additional functions, e.g., function as wireless (Wi-Fi) routers for general or dedicated uses to provide information for screening, alerts, routing instructions, etc. Although a dashed boundary 218 is included to aid understanding, it is to be understood that various components within the system can be varied, structures substituted, and so forth can be included in place of or in addition to those described. While geolocation via radio type signals is discussed, global position system (GPS) technology can be used to provide substantially the same functionality, such as through use of included GPS positioning hardware/software in the smartphone and/or the mobile communication service provider. Example commercial providers of geo-location technologies/beacon systems include but are not limited to Beacon Micro, LLC (St. Louis, Mo.); Bluvision, Inc. (Fort Lauderdale, Fla.); and Cisco Systems, Inc. (San Jose, Calif.).

Other technologies can be used in conjunction with a system of the present disclosure to locate a mobile device within the local environment, e.g., triangulate the device's location. In an example, a radio frequency identification (RFID) reader may be used by a traveler (such as by placing his/her electronic passport containing an RFID chip) to identify that he/she is present within the local environment 202 and/or to supply information to the system 200. In the previous example, the passport functions as a token of the individual.

In some instances, the individual's location can be authoritatively or at least partially authoritatively established by obtaining information (such as a PIN or other information likely known only to a particular individual) via the device that is affirmatively identified through geo-location to be within the predetermined location. For example, a traveler is asked to input a PIN to a located smartphone to establish and/or confirm that the traveler is accessing the portable device that is determined to be within the local environment. In the previous example, the system, e.g., the front end system 204, can establish that the smartphone 206 is present in the location, and that an individual that is aware of an associated PIN is likewise present.

Biometric information collected for example by a smartphone can be used to establish an individual's presence in the local environment, e.g., that the supplied biographic information is associated with biometric information for a particular individual even though the biometric information is not used for authoritative biometric identification. For example, a user may implement a smartphone to take a self-portrait, commonly known as a “selfie,” that is communicated by a smartphone in conjunction with his/her biographic information to establish/at least partially establish that the biographic information originated with a particular individual and that the particular individual is physically present in the local environment. In the previous example, the user still may be required to submit biometric information (facial image, fingerprint, iris scan) via a trusted device such as a touchpoint as part of an overall screening process. The system, e.g., front end system may use the facial image or selfie for other purposes, such as down-selecting reference images from a gallery, using the selfie as a basis for excluding the individual, etc., even though biometric information from a trusted touchpoint device is used for conclusive identification and/or exclusion. Biometric information used for purposes other than conclusive identification and/or exclusion may be held to a lesser predetermined acceptable use threshold than that used for conclusive identification/exclusion. For example, the front end system evaluates a facial image from a smartphone to determine that the image is ninety-seven percent (97%) likely to be that of the individual associated with the provided biometric information. Conclusive identification or exclusion may be done to a comparatively higher level such as ninety-nine point nine, nine, nine, nine percent (99.9999%).

Upon determining that a mobile device is located within the local environment 202, the front end system 204 can send an electronic receipt to the mobile device. In embodiments, the electronic receipt can be sent to even untrusted mobile devices, by virtue of authenticating that they are physically located at the local environment 202.

In some embodiments, the systems, methods, approaches, and techniques of this disclosure implement a constraint other than geo-location. Example other constraints include time, username/password, a unique identifier, e.g., an assigned number, personal identification number (PIN), SIM card number, etc. For example, when the system interacts with an untrusted device (e.g., smartphone) to obtain machine readable information from the untrusted device, the system can obtain a unique identifier from the device. Subsequently, if an untrusted device attempts to present the corresponding machine readable information and its corresponding unique identifier does not match, the system can generate an alert.

In an example, the system or a component uses a temporal limitation to restrict one or more of data input, transmission, receipt, time stamping, pre-processing, merging, processing, storing of information, receipt generation, link generation, encryption, receipt transmission, and so forth. In the preceding example, a short time frame (e.g., an hour or two) may be used to ensure a person/mobile device is physically present, ensure or mitigate against an individual being physically remote from a predetermined location even in situations in which geo-location is not implemented. It is to be appreciated that multiple constraints (e.g., time and location) can be implemented by a system or by components or devices included in or used in conjunction with the system.

In embodiments in which a constraint is implemented, the system or a component can be configured to test the constraint, such as by inspecting received information for information associated with the constraint. For example, the front end system 204 or central resource 208 inspects information received from a mobile device (smartphones 206-206B are illustrated) for a time stamp or location information. The foregoing information may be included in metadata transmitted in one or more packets of information from the mobile device, e.g., header data. If present, constraint-related information is identified. For instance, the central resource 208 or front end system 204 inspects and identifies location information (e.g., coordinates) in the metadata. The identified information is then compared to reference constraint data that may be separately retrieved or maintained in a register, database, or lookup table. For example, if the system uses time as a constraint, the central resource 208 can identify a flight number in the received data to determine when the flight is anticipated to arrive/depart and then compare that time with a timestamp in the received information to determine whether the information is in or out of an allowed submission timeframe or window. In the previous example, the system or device performing this task may consult a lookup table, registry, or database of flight information to obtain the reference time or the bounds of the window.

A substantially similar process(es) may be performed for other types of constraints. For example, the front end system 204 inspects received information packets for geo-coordinate information, identifies geo-coordinate information if present, obtains/compares the received coordinates with reference coordinates and then determines whether the coordinate criterion is met or not, such as by evaluating whether or not the received coordinates are within those permitted. If met, the process can proceed, if not, the information can be rejected and (optionally) the sending device is notified of the rejection. Optionally, the outcome of the constraint test is stored for reference. For example, the central resource stores the outcome (e.g., success/fail) in association with one or more of: unique identifier, name, flight number, or location (e.g., intended port-of-entry). Underlying information may be stored as well.

Referring again to FIG. 1, in examples, an overall environment 100 may comprise multiple predetermined locations 102 supported by a front-end system 104 that is geographically co-located or arranged/configured to promote efficient operation of the system/devices within the local environment relative to other resources in the system. For instance, a server and corresponding communication resources and so on are established at an airport to facilitate efficient communication, information access, and so forth in comparison to a system that does not include a front end system, although such systems (e.g., “front-endless”) are specifically contemplated. Embodiments are also contemplated in which the system implements multiple front end systems including examples in which multiple front end systems support a local environment, e.g., servers dedicated to portions of a predetermined environment such as a particular terminal in an airport. In some embodiments, the functionality associated with the front end system 104 is provided in a distributed manner, such as in a cloud or virtual type configuration.

Some system components are mobile and serve other purposes. For example, a user supplied smartphone/mobile computing device 106 (e.g., BYOD components) can join/leave the system based on use, and also can join/leave the system independent of physical location (e.g., the local environment 102 can allow mobile devices 106 based on characteristics other than physical proximity, such as by including mobile devices 106 that correspond to ticket holders destined for the airport at which the local environment 102 is based out of). For example, a traveler inputs his/her travel information via a smartphone 106 during flight, and then joins the local environment of the system upon entering a portion of the terminal corresponding to the predetermined area 102. In embodiments in which the system implements a time constraint, a mobile device may join by communicating information within an allowed time period (e.g., the system does not allow the mobile device to join until the allowed time period). The smartphone 106 may have already provided at least a portion of the information prior to joining the system. For example, the smartphone 106 provides the information via a cellular network as the plane is taxiing to the terminal. In this scenario the smartphone 106 joins the system by for instance completing a hand-shake procedure with the system, e.g., with the front end system 104 and/or the central resource 108. In instances in which devices join/leave the system, the components remaining in the system can be dynamically reconfigured or resources allocated based on the resources that remain in the system, design preference, resource allocation, and so forth. A mobile device may join the system and then leave or drop-off until rejoining once the device/person is in the predetermined location or communicates within the acceptable window of time.

In embodiments, systems, devices, methods, and approaches for merging data from trusted and untrusted devices are constructed to be part of an identification process. An identification process may be part of a screening process. Example screening processes include border control screening, transportation screening, testing, licensing, and so on. For example, the local environment 102 can be an airport, a port of entry (which may be at an airport, a sea port, or land) operated by U.S. Customs and Border Protection (CBP), a checkpoint such as a Transportation Security Administration Security (TSA) checkpoint, a test facility, or the like. In such instances, the hardware, software, processes and methods may be configured to accommodate requirements of such identification and screening processes. The methods, procedures, and techniques implemented by the systems, devices, and/or components can be based on or at least partially based on a level or degree of trust associated with the device and its information.

As illustrated in FIG. 1, the local environment 102 includes a touchpoint device 114 (e.g., a kiosk) and a front end support computing system 104 communicatively coupled by a network 110. The illustrated touchpoint 114 is representative of one or more touchpoints (touchpoints through “N” are illustrated) or multiple touchpoints that are co-located within a predetermined area, e.g., port of entry, a Transportation Security Administration (TSA) checkpoint, checkpoints for a particular terminal, an airport, and so on.

A touchpoint 114 is representative of functionality and corresponding structure to collect biometric information, although in some embodiments a touchpoint can be used to collect biographic information (e.g., travel information) or collect biographic information to be used to reference information within the system or that can be obtained by the system.

For example, a user implements a touchpoint to input his name, “Charles Winters,” which is implemented by the front end system and/or central resource to call-out or request information from third-party resources, if for instance the central resource lacks information for Charles Winters. For example, the touchpoint includes hardware such as an image capture device, e.g., a camera, supported by software. Example biometric software includes but is not limited to Nexa|Face™ or AwareABIS™ from Aware, Inc. (Beford, Mass.); Integra-ID™ or NeoFace™ from NEC, Corp. of America (Irving, Tex.); BioID™, BioID GmbH (Nurnberg, Del.); MorphoBIS™, MorphoTrust (Alexandria, Va. (now Idemia Inc.)); BioMatch™ Precise Biometrics AB (Lund, Sweden), and so on.

In other embodiments, touchpoint 114 interaction is triggered via a mobile device, rather than the user physically interacting with a touchpoint. For example, a user implements a smartphone 106 to transmit information to one or more of the touchpoint or front end system 104 to trigger user interaction with the touchpoint 114. An example of the foregoing is a touch point scanning a barcode displayed on the user's smartphone to access information on the mobile device 106 to be provided to the system, e.g., the front end system or central resource. In this way, the amount of time a user spends interacting with the touchpoint 114 is minimized in comparison to if this had been done by the user while physically interacting with the touchpoint. Thus, instead of inputting information (e.g., name, unique identifier, flight number, test code, destination country) as a precondition to collecting biometric information, a touchpoint may present a screen or audible instruction(s) that requests a user to confirm precondition information that has already been collected (thereby saving time), requests he/she initiate biometric collection, or the like.

A touchpoint 114 may be a trusted device because it is within the custody and control of an entity controlling the system or an entity that has a legal relationship with the entity controlling the system, e.g., an airport authority. As used herein, “trusted” means the degree to which something is treated as legitimate and the degree to which something needs to be further authenticated. For example, a central resource 108 is configured to associate a high trust level with biometric information from a touchpoint, because the touchpoint is operated, owned, or maintained by an entity that is legally required to maintain the device's technical capability, security posture, and the like, thereby enabling the resulting information from that device to attain a corresponding level of trust. In some instances, a system assigns a trust level to information based on one or more of software (including but not limited to biometric identification and security software), hardware, and so forth. In these situations, the device/component that provides the information includes information about one or more of the hardware, software, or encryption protocol implemented. The central resource 108 may implement information such as this to assign the data a corresponding trust level.

In embodiments, the touchpoint 114 is constructed to perform other functions, such as accepting input biographic information, e.g., via a keyboard, a simplified keyboard, a touch screen, and so forth. In these instances, a touchpoint includes additional hardware/software that enables it to conduct the additional functions that enable collection of information beyond just biometric.

In embodiments, the touchpoint 114 can provide directions that are understandable to a user. For example, if a user needs a particular type of service, the touchpoint 114 can provide directions that direct the user to proceed to a particular desk to receive the particular service. The touchpoint 114 can send such directions to a mobile device, such as a smartphone, carried by the user so that the user can refer to the directions on the go. Such directions can be sent even if the mobile device is untrusted. Furthermore, the touchpoint can provide initial directions encoded in a machine readable format, such as a two-dimensional barcode. The touchpoint can then process information associated with the user, and then provide subsequent, e.g., updated directions to the user. In an example, the touchpoint 114 can provide initial instructions to a user's mobile device encoded in a two-dimensional barcode, obtain biographic information from the user, process biographic and/or biometric information for the user, and then send a text message to the user with updated directions.

Other suitable biometric information collection devices include but are not limited to scanners (e.g., an iris, fingerprint, palm print, facial scanner) or other types of detectors that can be included with or used in place of a camera. Other biometric information that can be collected includes a fingerprint image, an iris scan, a body scan, and/or actions associated with behavioral traits, voice pattern, walking gait, and other such biologically identifiable traits. The image capture device is operable to capture biometric information. For example, a user implements a camera in a kiosk-type touchpoint to capture an image of his/her face for inclusion with user biographical information.

A local environment 102 may include a variety of hardware and hardware configurations. Some biometric information collection devices (e.g., cameras) may be dispersed at locations within the local environment, e.g., on a jet bridge leading to an aircraft. These biometric information collection devices in embodiments are communicatively coupled to the front end system 104, coupled to a dedicated resource (e.g., a biometric information server) that operates on behalf of the front end system, central resource, or so forth. In some instances, such biometric collection devices may interact with the touchpoint (either directly or indirectly, e.g., via a front end system) to function as a unit. An example of the foregoing is that a facial image collected by a surveillance camera in a hall containing the touchpoint 114 is used for biometric identification by the system (e.g., the touchpoint, biometric service (e.g., server), front end system, central resource). Such an arrangement can be used to augment information captured by the touchpoint 114. For example, a camera in the hall is used to capture a user's profile to augment a frontal facial image captured by the touchpoint or to ensure only one individual interacts with the touchpoint at a time.

In another embodiment, a flatbed type scanner includes a sensor that acts as a slap scanner (e.g., a four finger simultaneous plain impression scanner) to capture fingerprint information from the user's fingers and a camera that is suitable for capturing an image of a token associated with a user. For example, the flatbed scanner includes a light source and corresponding detector that is operable to collect fingerprint information while another light source and detector are included in the sensor to collect information, e.g., an image from the passport. In some instances, a scanner or image capture device is implemented for multiple uses, e.g., capture an image of a user's face and obtain an image of a barcode. In another example, a user places a page including biographic information from his/her passport on the scanner for image capture by a camera before placing his/her fingers on the scanner for biometric capture.

A touchpoint may include an RFID reader to wirelessly collect information from an electronic or e-passport that includes RFID technology, e.g., a first and second antenna, memory, and so forth in addition to or in place of optical based collection. In some embodiments, passport information is collected optically and from an included RFID “chip” for comparison. For example, a touchpoint includes an optical two-dimension barcode scanner and a wireless RFID reader to obtain information from the passport to make altering or presenting a fraudulent document (passport) comparatively more difficult in comparison to a system that implements single mode information collection.

In another example, and as will be discussed in detail below, a user places on the scanner, or otherwise holds within scanning range, his/her smartphone bearing on its display an image of a two-dimensional barcode, so that one or more of the touchpoint, the front end system, or a central resource can obtain, access, retrieve information referenced by or contained in the two-dimensional barcode or Quick Response code (QR CODE, Denso Wave Inc.) Other image capture devices can be used for this and substantially similar purposes. For example, a camera constructed for capturing facial images can be used to capture an image of a barcode (e.g., machine readable information) output on a display included on a mobile device, such as a smartphone. Other image capture devices constructed for capturing an image of a barcode can be used as well or in different embodiments.

In embodiments, using a two-dimension or 2D barcode permits a system to relate information submitted via the smartphone (e.g., prior to being physically present for biometric information collection) to a biometric capture event, and in some instances permits that information to be merged with collected biometric data. In this example, as well as in various embodiments consistent with this disclosure, linking information (e.g., the 2D barcode) is used by the system including its components to exchange, relate, or access information so the system can merge information (e.g. biographic/travel information) obtained from different resources including resources associated with different trust levels. Linking information may be information encoded into machine readable format (and likely encrypted as well) or a link to the information, e.g., location of the related information in memory.

Barcodes, such as a two-dimensional barcodes, offer the benefit of not being readily human readable. For example, while a two-dimensional barcode is used to convey information, that information is encoded in the barcode so it is not readily discernable to humans. In some instances, the information encoded in or accessible via the barcode is encrypted, such as by public-private key encryption, so appropriate hardware/software (and key information) is needed to obtain or access the information. In this manner, even if an intervening party were able to implement a barcode reader, the underlying information protected by the encryption and/or location of the information would not be accessible. An example of the foregoing is the use of an application program interface (API) that implements an encryption/decryption algorithm (e.g., PKI type encryption) that when executed by a computing device is able to access or discern the underlying information embodied in the barcode.

In some examples in which an image is captured, a digital representation of the image or picture is embodied in a file. The image may be contained in a variety of file formats including, but not limited to, a jpeg file, a tiff file, a gif file, a pdf file, and so forth. As will be discussed in greater detail below, image capture can include capturing a video or multiple images (e.g., a gallery of images) and down-selecting a particular image using an algorithm to select one or more image that meets or exceeds a quality threshold (e.g., is suitable for biometric identification or to obtain or access information associated with the linking information) or a predetermined condition, e.g. a profile view. A system or device may retain a copy of the file containing the image for recordkeeping purposes, subsequent evaluation, disaster recovery, and so forth.

Turning again to FIG. 2, a front end system 204 is illustrated in additional detail in addition to other aspects of the present disclosure. In the illustrated example, the front end system 204 is shown as a physical computing system, e.g., a server that supports one or more mobile devices (smartphones 206-206B), beacons (216A-216C), and/or touchpoints 114 such as those of FIG. 1. In additional embodiments, multiple devices/systems are used to provide the described capabilities of a front end system. In some embodiments, the capabilities and functions of the front end system 204 are supported by a distributed computing configuration or a cloud-type hardware/software configuration. The front end system 204 in embodiments includes hardware/software to support the touchpoints and/or the mobile devices associated with the predetermined location such as by facilitating communication of information between the touchpoint(s) and the central resource 208.

The front end system 204 includes one or more communicatively coupled communication units 220, processors 222, and memory, illustrated as “local memory” 224. The communication unit 220 is representative of one or more devices able to communicate information to/from other devices and components including in instances those included in or external to the system. Example communication units include but are not limited to wireless modems (such as an 802.11 compliant unit), wired (e.g., Ethernet-ready) or other such communication interfaces, and/or a cellular communication transceiver. Example 802.11 compliant modems/cards include but are not limited to those compliant with 802.11n, 802.11ac, 802.11ad, 802.11ah, 802.11aj, 802.11ax, and the like wireless local area network standards promulgated by the Institute of Electrical and Electronics Engineers (IEEE), New York, N.Y.

Although a single processor and memory are shown, the front end system 204 can be constructed with multiple processors and memory. The processor 222 is representative of hardware that is capable of processing computer executable instructions, such as central processing unit that executes a program of instructions. In embodiments, the processing unit 222 implements an operating system which is a set of instructions that allows the processor to perform specialized instructions according to a program run on the operating system/processor platform.

Local memory 224 is representative of a wide variety and types and combinations of memory suitable for storing information in an electronic format. Example memory includes but is not limited to random access memory (RAM), hard disk memory, removable medium memory, flash storage memory, and other types of computer-readable media including non-transitory data storage. For example, local memory 224 may store a variety of information obtained from the central resource, mobile devices, touchpoints, and so forth.

In embodiments, local memory 224 holds information for a predefined period of time, e.g., for 24 hours prior to an anticipated transaction. Local memory 224 may release information from memory after a predetermined time, occurrence of an event (e.g., the central resource confirming it has information for a transaction), or the like. In an example, the processor 222 is configured to control the memory contents (e.g., wipe the memory) based on various such predefined or triggering events. Local memory can be configured in a variety of ways based on design preference, performance considerations, and so forth.

FIG. 2 illustrates the front end system 204 as including an information module 226. In embodiments, an information module 226 is representative of hardware and/or software that is constructed to function as described in this disclosure. For example, the information module 226 is a combination of software (such as a program of instructions that is stored in local memory) that is useable by the processor 222 to provide the described capabilities and functions, such as when the embodied instructions are executed by the processor included in the front end system. As illustrated and for ease of understanding, the information module 226 includes a biometric module 228 and a constraint module 230. Also as illustrated the information module 226 includes a biographic module 232 and a linking module 234. While shown and described as individual modules, the supporting hardware/software can be configured as an integrated program of instructions to provide the described functionality, such as through the use of application program interfaces (APIs) that permit individual programs to interface to one or more other programs and provide one or more graphical user interfaces (GUIs) output on a display 236 to a user to access information or exercise control over the front end system including touchpoints, beacons, biometric capture devices, and other resources.

In embodiments, the front end system 204 is constructed to receive or collect biometric information from included touchpoints and other biometric capture devices, such as a camera that is included in or associated with the predetermined area such as the local environment 202, e.g., a camera included in a port-of-entry hall. This is represented as a biometric module 228, which comprises a combination of hardware and software that is capable of receiving or obtaining biometric information or information derived or otherwise obtained from biometric information.

In embodiments, the biometric module 228 is constructed to compare captured biometric information or information derived from the biometric information with reference information (e.g., a gallery of biometric information from facial images or multi-modal information, e.g., fingerprint, iris) to match and/or exclude an individual associated with the captured biometric information from being associated with an identity to which it was compared and referenced to, e.g., a hash of an image of Charles Winter's face is associated with his biographic information. For example, the biometric module 228 compares a hash/digital signature of a facial image captured on a jet way with a gallery of digital signatures (facial) of anticipated passengers for a particular flight.

In some embodiments, the biometric module 228 is configured to manage biometric functions under control of the front end system 204. For example, the biometric module 228 manages operation of touchpoints' biometric activities, biometric capture devices (e.g., “standalone” cameras), and optionally that of a biometric resource, e.g., a biometric server that handles various biometric related functions on behalf of the biometric module. In examples, the biometric module 228 is configured to handle touchpoint requests for biometric information, schedule biometric identification tasks among touchpoints, integrate biometric information from multiple resources (e.g., standalone cameras), manage biometric information requests to/from the central resource, manage touchpoint biometric information collection, and so forth.

The biometric module 228 in conjunction with the biographic module 232 can be configured to include such information in merged information or in association with the merged information, e.g., linked to or as metadata to information in the merged data. Some of the functionality of the information module 226 can be at least partially provided by hardware/software included in a touchpoint for a similar purpose and implement available biometric identification algorithms and software for identification purposes.

In embodiments, the front end system 204 manages the touchpoints under its control. In such embodiments, the front end system 204 stores the collected/generated information due to its management function in applicable records and/or associated with individual records, e.g., linked to applicable records in a relational database maintained by the central resource. For example, the biometric module 228 is constructed to broker ad hoc requests from the touchpoints for access to the central resource 208 or front end resources, if for example, an asserted identity does not match an identity that is anticipated to be asserted, e.g., preloaded to the touchpoint/front end system. In the previous example, upon determining that the collected biometric information does not match to a predetermined threshold, the system can then confirm/attempt to confirm that the collected biometric information does not match an individual that is to be excluded. For example, if a touchpoint fails to match an in-question individual to a predetermined threshold, it can request the front end system 204 interrupt itself and have the biometric module 228 check whether the individual in question is to be excluded (e.g., corresponds to biometric information represented in a prohibited list), fails to match (e.g., does not match to a sufficient degree an individual represented in the central resource), apply a different or multiple biometric identification algorithms, or the like. In other embodiments, the biometric module 228 provides the touchpoint with additional information and a corresponding biometric module in the touchpoint performs the exclusion comparison or check.

In some instances, the biometric module 228 interfaces with biographic module 232 to obtain biographic information to aid or augment biometric comparison, such as by a touchpoint under the front end systems control. The biographic module 232 can serve as another option to authenticate at least some aspects of an individual's identity. For instance, prior to a touchpoint finally rejecting an individual as a non-match or commencing an exclusion comparison, it may place an ad hoc request for the biometric module 228 to biometrically identify the individual. If the biometric module 228 is not able to positively identify the individual to a predetermined threshold, the biographic module 232 can retrieve biographic information from local memory or the central resource for use in questioning the individual, e.g., mother's maiden name, middle initial of a sibling, and the like. If the individual is unable to answer the biographic questions, the biometric module 232 either in the front end system or that of a touchpoint may commence determining if the individual is to be excluded, e.g., on a banned list. In contrast, the touchpoint or front end system biometric module may obtain additional biometric information from the individual for comparison if the individual correctly answers the biographic questions. This additional information may be of the same type or of a different mode, e.g., fingerprint and/or iris, for increased accuracy relative to for example facial identification. In some embodiments, instead of the biometric module attempting to identify the individual, the information module 226 is configured to proceed with providing biographic information for use in questioning the individual via a GUI output on a touchpoint display.

In another example, the biometric module 228 is configured to lockout reference identities (e.g., information/records for identities anticipated to be asserted) while the touchpoints use the reference identity for comparison. This “lockout” may be temporary (e.g., for a set time, until the occurrence of an event (no match)) or until the individual is checked out of the system, e.g., boards a vehicle, leaves his/her final destination, and the like. A lockout can be used to protect or otherwise control the use of a given identity, e.g., by preventing modifications to and/or uses of the reference identity that is being subject to the lockout.

For instance, responsive to receipt of input that indicates that the identity “Charles Winters” is being asserted via a particular touchpoint, the information module 222 (e.g., the biometric and/or biographic modules) locks out or prevents other touchpoints under its control from using the identity “Charles Winters” as a basis of identification. This input may be received via a user entering biographic information or through the use of linking information, e.g., the touchpoint scanning a barcode output on a display included on Charles' smartphone. Accordingly, the lockout prevents fraudulent use of the locked out identity, e.g., by an impersonator, based on legitimate use of that identity having been asserted to trigger the lockout.

In some embodiments, a lock is provisional until occurrence of an event, e.g., a final determination. In situations such as this, the touchpoint can preliminarily identify the individual to a predetermined initial threshold (e.g., to eight-five percent (85%)) confidence, and the final lock can be imposed later, responsive to a final determination threshold (e.g., to ninety-eight percent (98%)) confidence. In this way, the front end system 204 can preliminarily identify individuals in a time conscious manner without needing to impose locks, and then handle exceptions that fail to meet the comparatively heightened standard at a later time or apply a higher threshold and then impose locks as needed. An example of the latter is if the system is configured to apply an initial lower threshold (passenger check-in) and then apply a higher threshold at a later stage and/or point in time (during customs inspection). In such an example, the system could wait until the later point to lock out the identity, thereby basing the lockout on a heightened determination threshold.

Information associated with one or more of the lock out, initial comparison, final comparison and so forth may be stored in or associated with the relevant identity record 240 or in a temporary register, such as in local memory 224 or in memory associated with the central resource. In the latter situation, the front end or touchpoint constructed for this purpose can provisionally hold the related information in for example a register in local memory and then responsive to a final match, store and/or communicate at least a portion of the collected/generated information to the front end or central resource. The foregoing includes information derived from the collected/generated management information, e.g., a facial hash. It is to be appreciated that other biometric capture devices can be used as well (e.g., a standalone camera in a terminal) and relevant information merged or subsequently associated with the merged information.

For example, prior to finally determining that an individual does not match an asserted identity, the biometric module 228 polls other biometric collection devices for biometric information that can be used in identification. For example, before finally rejecting Mr. Winters, the biometric module 228 polls other biometric collection devices (e.g., port-of-entry gallery cameras or a biometric sever on behalf of the biometric collection devices) to obtain facial images of Charles for comparison in an attempt to meet the predetermined threshold, rather than issuing a final rejection/negative final determination based solely or primarily on information from a biometric information collection device in or associated with the touchpoint.

The system/methods of the present disclosure can use other modes of biometric identification if a predetermined threshold is not met, e.g., use iris or fingerprint if facial recognition is not sufficient to meet a predetermined threshold. For example, if facial recognition does not meet a predefined accuracy threshold, the biometric module 228 can be configured to have the relevant touchpoint request that the individual is to supply a fingerprint to ensure a match/avoid rejecting the individual. A touchpoint biometric module can be configured in a substantially similar manner. In such situations, the information module 226 may handle an ad hoc request from the touchpoint for information, processing support, application of different identification algorithms, and so forth.

For example, upon determining that an individual asserting the identity “Charles Winters” is indeed “Charles Winters” (such as by comparing a hash of collected biometric information to a reference hash value of reference biometric information) for which the front end system/touchpoints had a reference identity, the biometric module 228 may communicate the results of the identification, an associated timestamp, and so forth related to the identification transaction to the central resource 208. In the previous situation, the front end system 204 and central resource 208 may implement handshake type operation or some other confirmation process as part of the information exchange. Concluding the exchange may be associated with one or more of releasing information from local memory on the front end system, removing a flag for the corresponding record (on one or more of the front end system or central resource), and so on. The point in time at which the communication occurs in the previous example, may vary based on operating conditions, communication link availability, design preference and so forth. In some embodiments, the front end pushes this information while in others the central resource may (periodically) poll the front end for the information or may do so in response to an event (e.g., an intermediate trigger event) such as network availability or another selected based on design preference. Example software may be based on, but is not limited to, commercial type database management software (e.g., Oracle database management software (Oracle, Inc., Redwood Shores, Calif.) and their functional equivalents. Other example systems/hardware include, but are not limited to, that described in U.S. Pat. No. 9,268,904 entitled, Systems and Methods for Biometric Data Management Using Relational Database Management Systems (RDBMS) which is hereby incorporated by reference in its entirety.

The included touchpoints can be configured to provide the functionality associated with the biometric module 228 based on a variety of factors, including but not limited to design preference. For example, the front end system 204 or the central resource 208 sends the touchpoints information for individuals that are anticipated to seek identification within a predetermined time frame. For instance, twenty-four (24) hours prior to scheduled departure, the central resource (in some instances via the front end system) sends the touchpoints information that corresponds to individuals scheduled to pass through the predetermined location. In the foregoing example, the central resource 208 sends information (e.g., digital facial signatures, digital fingerprint signatures) that is intended to be used for reference when attempting to identify or exclude individuals. In some instances, this pre-loading of reference information avoids having to load information at the time of arrival of the individual, and thereby enables the touchpoints to be ready ahead of time. Furthermore, the pre-loading can occur at times of low traffic/loads at the front end system 204 or central resource 208. Accordingly, this approach minimizes interruptions (e.g., where a touchpoint would on-demand request identification service based on the unanticipated arrival of an individual to be identified at a touchpoint) to the front end system 204 or the central resource 208, in comparison to a system that does not implement this approach. The system/touchpoint may interrupt/implement ad hoc requests in instances in which reference information is not present and/or the front end can act to lock out identities/records from being used as a basis of comparison as individual are identified.

The foregoing can be done without regard for whether the information is pushed by the device that collects the information (e.g., touchpoint) or pulled by the front end system 204 requesting the information, such as by polling the device collecting it. An example of the latter is a computer enabled video camera that seeks to identify human faces in the captured video and then applies a facial recognition algorithm to the information to generate or derive information from the image, e.g., a signature of the individual's face image.

The biometric module 228 may be configured to manage or broker requests and tasks among the touchpoints and other devices that it serves. For example, the biometric module 228, provided as a cloud type local resource, manages the touchpoints individually and/or relative to each other to maintain a specified throughput or average time for the overall group of touchpoints. For example, the biometric module 228 can change or vary procedures employed by the devices under its control. For instance, the biometric module implements a lower biometric identification threshold at one stage of an identification procedure but then applies its normal (e.g., a higher) threshold at a later point in time, such as a time corresponding to an event (e.g., boarding) or the availability of resources, e.g., based on whether the central resource 208 and/or the processor 222 of the front end system 204 has availability.

In some embodiments, system components dynamically handoff/accept tasks based on operating conditions, exception handling, and so forth. For example, the biometric module 228 can include biometric identification software that is different from that implemented by one or more of the touchpoints, thereby allowing another layer of identification redundancy, e.g., based on a different identification approach. Examples in which the front end system biometric module 228 may be called on to perform biometric identification include, but are not limited to, before a non-match rejection or final matching to an identity included on an excluded list, such as to avoid a false positive or otherwise perform a redundancy identification check.

In some instances, a video camera pushes images or information derived from images to the front end system 204 or the front end system requests biometric information, which in some instances may be done by the front end system polling the video camera or doing so based on occurrence of a predetermined event. An example of a predetermined event is a video camera determining a human face is present in an image. In some instances, a predetermined event is determined by the front end system or a central resource.

While cameras are referenced throughout this document, a variety of biometric collection devices can be used. Examples include but are not limited to still cameras, video cameras, infrared cameras, microphones, motion sensors, electromagnetic sensors, and the like that are constructed to capture biometric information.

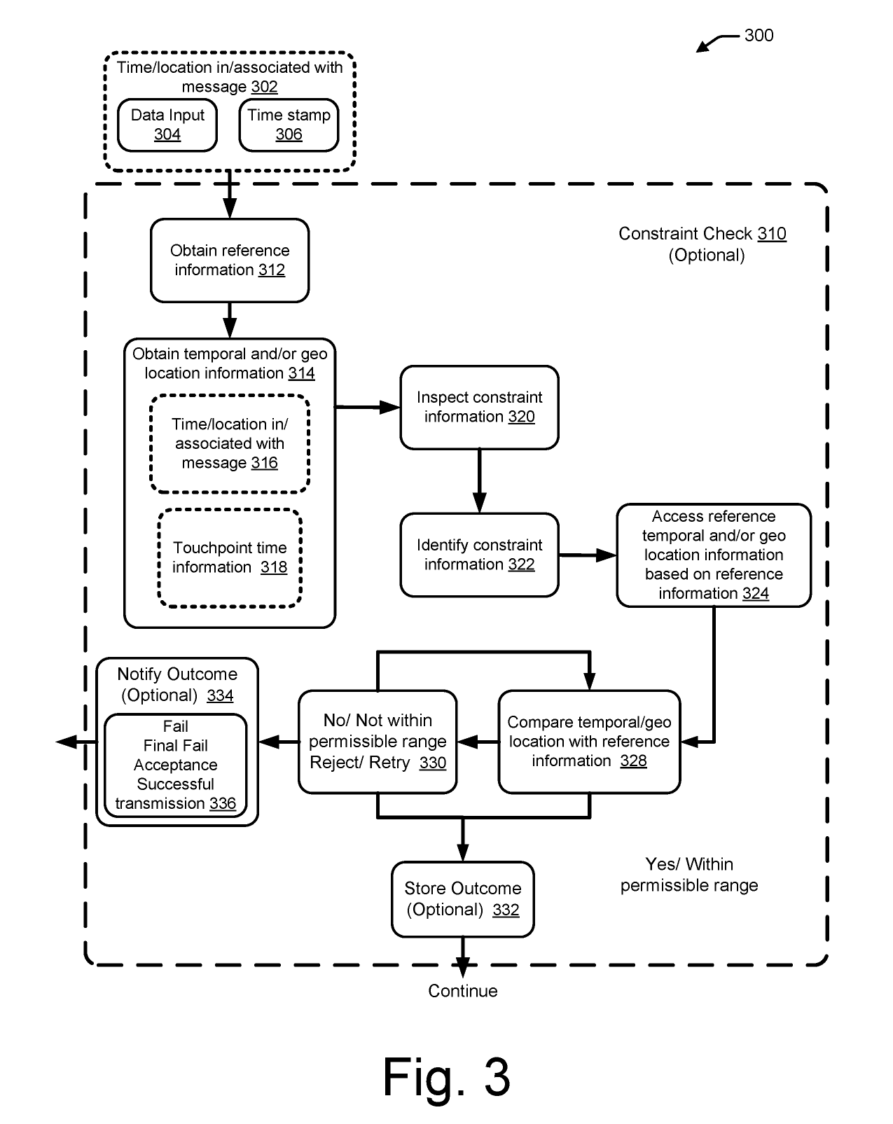

With continued reference to FIG. 2, as illustrated the front end system 204 includes a constraint module 230. The constraint module 230 is constructed with supporting hardware/software to impose one or more constraints on information provided/attempted to be provided to the system, e.g. provided to the front end system 204. For example, the constraint module 230 reviews metadata/packet header information to determine whether it meets a predetermined constraint, e.g., within a timeframe window, a predetermined geographic area, and so on. While the constraint module 230 is illustrated as being in the front end system 204, in embodiments, a touchpoint or the central resource may include a constraint module configured as described herein. Operation of constraint modules and associated procedures are discussed in conjunction with FIGS. 3-5C, below. A constraint module 230 can be variously configured based on design or operational preference.

For instance, the system is configured to geo locate one or more mobile devices in a predetermined location, such as a local environment, to ensure only mobile devices within that area are permitted to supply information for inclusion or incorporation into the system. For example, the constraint module 230 is configured to prohibit a user from supplying biographic information for merging with biometric information until the user's smartphone is determined to be geo located within (e.g., physically located within) the predetermined location. In the preceding example, the constraint module 230 in the front end system 204 is delegated responsibility from the central resource, such as by instructing the front end system to make a determination by comparing a geo location reported by the smartphone with a register of permitted geo locations. In this way, the central resource 208 can lock out or flag an associated record to prevent the central resource or other front end systems (such as front end systems supporting other facilities/predetermined locations) from changing information in the record (e.g., updating, manipulating information), and/or to permit the front end system to make a determination as to whether the mobile device is present in the predetermined location and update a corresponding record to reflect the determination. Upon completion, the information module 226/constraint module 230 can instruct the central resource to release the record, e.g., remove a flag.

Approaches other than a geo location may be used for substantially similar purposes based on design and operating preferences. For example, the system may implement a temporal restriction on the input of information to be merged by the system. An example of the foregoing, is the front end system 204 or the central resource 208 locking out or otherwise prohibiting the supplying of information to the central resource, a touchpoint, or the front end system until a predetermined time, e.g., five hours prior to an anticipated flight or expected merging of information from the trusted and untrusted devices.

This temporal restriction can be enforced in a variety of ways based on system configuration and design preference. For example, if information to be merged is supplied (albeit in an encoded and/or an encrypted form) in a two-dimensional barcode, a timestamp can be included in the two-dimensional barcode such that a touchpoint in conjunction with the overall system can reject the information if the included timestamp is not within the allotted timeframe. In embodiments in which a temporal restriction is imposed and the information (e.g., biographic information) is routed to the front end system and/or central resource for storage, the applicable component can reject the information if attempted communication/receipt of the information occurs before the allotted time window. In examples, one or more of a touchpoint, front end system or central resource rejects the information if it is sent before a pre-established time period. For example, users may be prevented from uploading travel and biographic information until two hours before anticipated arrival. In other instances, the supplied information is held in memory until the constraint is met, e.g., the time window is open. The constraint module 230 can enforce this restriction by comparing a date stamp provided or otherwise associated with the information with that stored in a database of arriving flights, a user profile, or information included in the submitted information or derived from submitted information and rejecting the information unless the information is within the allowable timeframe.

An example of a constraint module imposing a temporal constraint is if upon receiving biographic information from a smartphone, the constraint module 230 inspects metadata associated with the biographic information to determine if a timestamp is present, and if so, it determines if the included timestamp is within a permitted timeframe based on for example, a referenced flight number based on a lookup of the characteristics of the referenced flight number (e.g., based on a lookup of cross-referenced flight information). The constraint module 230 may do this by checking for a flight number in the packets containing the information. With a flight number obtained from the packets (e.g. in metadata), the constraint module in embodiments compares the flight number to a lookup table of flight numbers and times in order to match the flight number to a corresponding timeframe in the lookup table. Responsive to a determination that a flight number is not present in or with the information, the constraint module 230 can reject the packets containing the information and (optionally) notify a device communicating the information of its rejection (e.g., a notification that the corresponding timeframe is not yet active, and/or that the given flight falls outside acceptable timeframes). Responsive to determining a match exist between the flight number and one from the lookup table, the constraint module 230 obtains and/or calculates a time window based on that represented in the table.

Having defined or obtained a relevant timeframe window, the constraint module 230 can compare a timestamp included with or in the biographic information to determine whether or not the time constraint is met, e.g., whether the timestamp is within the window. If met, the front end system accepts the information. If the constraint is not met (e.g., responsive to a “no” determination), the constraint module 230 can reject the information and (optionally) send notification of the rejection to the originating device (e.g., smartphone). In other instances, the constraint module 230 iterates a predetermined number of times prior to finally rejecting the information and (optionally) sending a notification to the originating/communicating device. Other system components (e.g., central resource 208, touchpoints) can function in a substantially similar manner and include corresponding hardware/software to provide the described functionality.

As illustrated, the front end system of FIG. 2 includes a biographic module 232. The biographic module 232 is representative of functionality and corresponding hardware/software to support the collection, handling, updating, or processing of biographic information. Biographic information can be supplied via a mobile device (e.g., an untrusted or partially untrusted device) or from the central resource 208 with biometric information collected via a trusted device, e.g., a touchpoint. For example, the biographic module compares biographic information supplied by Mr. Winter's mobile device with pre-existing biographic information to determine if any information has changed (address change), determine if the supplied information indicates the individual supplying the information is an imposter or excluded, and so on. In another example, the biographic module 232, upon determining the supplied birthdate does not match that of an asserted identity, can flag the individual for different or heightened biometric identification procedures, for biometric exclusion comparison (e.g., collected biometric information compared for exclusion), additional or different biographic information questioning, and so forth.

In embodiments, the biographic module 232 is constructed to obtain record information from the central resource, and index the information from the records according to biographic information to minimize system resources used for biometric identification/exclusion. The foregoing can be done via the biographic module 232 requesting information such as for a departing vessel (e.g., pulling information) or the central resource 208 pushing the biographic/biometric information to the front end system 204 for storage in local memory 224. The biometric information (e.g., hashes of facial images) can be indexed based on associated biographic information such as name, passport number, and/or flight number, to minimize the computing resources in comparison to not organizing the information based on related biographic information.

As illustrated, the local memory 224 of the front end system of FIG. 2 can store a record 240 including merged information 242 and unique identifier 248. The local memory 224 also can store an electronic receipt. The merged information 242 can include biographic information 244 and/or biometric information 246. In some instances, the biographic/biometric information (and/or record 240) is stored in local memory 224 prior to anticipated use by the front end system/touchpoints. Then as individuals present themselves for identification, the biographic module uses the biographic information at least at first to down select which biometric information is to be used for reference. For example, in response to a user inputting a passport number or asserting an identity via a 2D barcode, the biographic module retrieves from local memory 224 at least a portion of the biographic and biometric information for the individual associated with that passport number. This may be for instance the passport holder's name, height, eye color, address, and corresponding biometric information, e.g., a hash of a facial image. The biographic module may flag the record/identity in local memory to prevent the biometric module or the touchpoints from using the identity/record until an identification determination is complete. In some embodiments, the biographic module communicates the lock/flag to the central resource to prevent the corresponding record/identity on the central resource from being used as a reference for identification/exclusion. In embodiments, the biographic module manages biographic information in local memory based on, but is not limited to, commercial type database management software (e.g., Oracle database management software (Oracle, Inc., Redwood Shores, Calif.) (e.g., relational database software) and their functional equivalents.

As noted above in embodiments, biometric information is indexed to or otherwise related to corresponding biographic information, so the biographic module can manage, retrieve, and the like biometric information on behalf of the biometric module. In instances such as this, the biographic module 232 can retrieve a hash of a biometric feature (facial image, iris scan, fingerprint image) in response to a user providing linking information (e.g., a 2D barcode) that includes or links to for example a user's driver's license number.

Reference will now be made to FIGS. 1 and 2. As can be seen in FIG. 2, the front end system 204 and information module 226 includes a linking module 234 that is representative of functionality and corresponding hardware/software to link information from multiple devices including components of a system of the present disclosure. In embodiments, the linking module 234 merges information from trusted and non-trusted or partially trusted device so information is integrated although it may be provided via multiple devices, e.g., smartphone and touchpoint. In some embodiments, the linking module is constructed to retrieve linked information, such as from local memory 224 or memory associated with the central resource. As noted briefly above, this may be done in a variety of ways as explained in the “Overview” here and throughout this disclosure, such as in conjunction with the drawings. The latter two embodiments will be discussed later in this disclosure.

Responsive to a user submitting responses (answers, which may include biographic and other information) to questions via a mobile device, the mobile device (e.g., an application or “app”) generates a 2D barcode for output on a display included in the mobile device. In this example, the underlying information, such as responses to security or boarder control questions, may be encoded in machine readable format and (optionally) encrypted using public key encryption (PKI) to protect the information from unauthorized access. That underlying information itself can be presented in the form of the 2D barcode, e.g., as data encoded within the 2D barcode. In other examples, the system generates a link to the underlying information, and the link is encoded as a 2D barcode. The linking information, in this case a 2D barcode, can be a unique identifier of the underlying transaction submission of the answers to the app on the mobile device. It will also be recognized that additional information can be included with the answers. For example, linking information can include one or more of a timestamp, geolocation information, system ID (SIM card number), user ID, and so forth. In instances, the information can be accessed or retrieved by the touchpoint or front end system by a user permitting a scanner in the touchpoint to scan the barcode or by otherwise communicating the linking information (e.g., barcode) to the system. The former is generally illustrated in FIG. 1. An example of the latter is a user wirelessly communicating an image file containing the linking information via a text message to the front end or touchpoint. The foregoing may be restricted to prevent remote submission such as by requiring the information come via beacon/wireless router in the local area or through use of a geographically constrained medium, e.g., BLUETOOTH.

In other embodiments, the linking information identifies a location of the submitted information in memory, such as memory associated with the central resource. For example, upon completing answers to questions via a user's smartphone, the phone/supporting application communicates the information and (optionally) any additional information to the central resource that in response communicates the linking information to the smartphone (e.g., via a 2D barcode) or information that is usable by the smartphone/app to generate the linking information that indicates how the submitted information can be located, e.g., a record number that is usable to identify the submitted information, including (optionally) additional information, in memory for the central resource. While the location can be identified directly, a registry can be used with the linking information indicating a registry entry that in turn is associated with a location in physical memory. It is to be appreciated that the various devices may likewise make use of PKI or other encryption and that the barcode or information usable to generate the barcode can be a unique identifier of the transaction, e.g. submitting the information to the central resource. The linking information (e.g., barcode) can be scanned by a touch point or other device, or communicated to the system, e.g., front end system, touchpoints, central resource as described above and throughout this disclosure.

The record 240 can include a record number or other identification used to reference the information on the central resource may also be used to locate the information when stored in memory associated with one or more of the front end system or touchpoints. The foregoing may be done directly through use of the same record number or done based on a schema that makes use the record number information, e.g., a derivative or augmentation of the record number.

Responsive to receipt of the linking information, the linking module 234 can use it to merge information. For example, prior to arriving for security screening an individual may use his/her smartphone to provide responses (answers) to border control questions, such as those included on U.S. Customs and Border Protection Declaration Form 6059B, responsive to receipt of the linking information the linking module can use the linking information to merge the provided information, so it is interrelated.

In another example, responsive to receipt of a barcode that indicates provided biographic information is stored in conjunction with record 032406122109, the linking module may indicate via a link or other reference that one or more of a facial image, an iris scan, a fingerprint image, or information derived from one or more of the foregoing is associated with the record number 032406122109. The foregoing biometric information may have been captured by a biometric capture device included on one or more of a touchpoint or other biometric capture device, e.g., a gallery of facial images captured by a touchpoint and a camera in a terminal. Biometric and biographic information can be physically merged, e.g., stored in memory in physical proximity, but this may not be done for a variety of operational considerations. While the linking module 234 may temporarily store the link and any collected information (e.g., captured/derived biometric information, biographic information obtained from linking information) in local memory such as in a temporary register, the information module can implement a schema that permits it/other system components to include one or more of the collected link, biometric information, or biographic information to be included or at least partially included in memory associated with the central resource, e.g., a database stored in memory co-located with the central resource such as at a later point in time.

All or substantially all of the collected information can be communicated to the central resource for storage or done on a case-by-case basis based on a variety of factors including, but not limited to, one or more of system resource (e.g., processing, communication), occurrence of an event, the system configuration (e.g., algorithm update), and the like. For example, the front end system communicates a facial image and the linking information to the central resource after hours based on the availability of processing/communication resources for an individual for which the system does not have a (predefined) recent image. In other instances, a portion of the information is retained (e.g., a frontal facial image, a hash of an iris scan, a copy of the link) for subsequent use (e.g., use as a reference in subsequent identification), while some information is not retained or is only retained until the applicable physical memory is rewritten/overwritten for another purpose. In this way, the touchpoint/front end system may limit what information it provides the central resource to that which is changed, did not previously exist on the central resource, or is meaningful according to a predetermined threshold, e.g., the individual grew a moustache or likely had cosmetic surgery that is not represented in previous images or a hash of the applicable biometric feature, e.g., facial image, fingerprint, voice print, gait, iris scan.

In additional examples, some collected information (whether captured in the case of biometric information or obtained such as information encoded in to machine readable linking information) is communicated at different points in time in comparison to other information. For example, the linking module 234/information module 226 communicates a link upon completion of an authoritative identification while waiting until system resources are free to communicate a hash of a facial image or an image itself. In the previous example, the link interrelates information included in a record in memory on the central resource with (at least temporarily) a hash of a facial image captured by a touchpoint under the front end system's control as part of a screening process stored in local memory 224. The central resource may temporarily store the link in a register until the occurrence of an event or a predetermined time. In other instances, a system including the central resource and front end system implements a common schema to reference the information so it is available and time-indexed across the system, whether accessed using a link at the central resource, at the front end system, and/or at the mobile device. Additional Examples of how the foregoing can occur and discussion of supporting hardware/software can be found in U.S. Published Patent Application 2016/0078581, entitled, Mobile Customs Declaration System and Method, which is hereby incorporated by reference in its entirety.

With continued reference to FIG. 2, optionally one or more dedicated resources are included in a system/predetermined location local environment 202 for receiving or collecting biometric information. In embodiments, a system includes a biometric information server 236 such as video server to handle images from one or more cameras dispersed about the local environment 202. A biometric information server 236 can perform a variety of tasks on behalf of the front end system 204, one or more touchpoints, the central resource, or other resources/components included in the system. The biometric information server 236 may perform some processing or preprocessing on behalf of the front end system 204. In embodiments, the biometric information server is dynamically tasked based on instructions from the front end system, the central resource, or in some instances touchpoints. In this manner, the biometric information server 236 handles biometric information generated by the biometric capture devices on behalf of the front end system.

The biometric information server 236 and capture devices can be configured in a variety of ways, such as a capture device preprocessing the underlying information (image) or providing it to the server or the front end system 204 in raw form. An example of the former is a video camera that applies a facial recognition algorithm to captured video to determine whether a facial image is present, and if so derive a hash of the face to be forwarded to, e.g., the biometric information server. The biometric information server in embodiments can identify an individual corresponding to the hash or include it in a gallery for comparison. For example, the biometric information server 236 using the facial signature may identify the individual walking in a terminal and then include a hash of the face in a gallery for comparison to minimize the time associated with authoritative identification. In this way, prior to a touchpoint or the front end system issuing a non-match or attempting to identify the individual from a larger dataset as part of authoritative identification, the component may compare a hash from an image captured during authoritative identification to that added to a gallery as the individual walked in the terminal.

In other examples, the front end system 204 tasks the biometric information server 236 to identify a particular individual based on his/her biometric information. In instances, the front end system 204 is configured to instruct the biometric information server 236 to scan individuals in a terminal to exclude them from a list of individuals that are not permitted to travel. In addition to or in place of excluding individuals, the system/front end system may attempt to affirmatively match collected biometric information (e.g., collected facial images) to reference identities on an exclusion list.

In still other embodiments, the biometric information server 236 is configured to collect and/or identify an individual possessing a smartphone to ensure that the individual using the phone corresponds to an identity linked to or associated with the smart phone. In the preceding example, an actual or anticipated location of the smartphone and the corresponding user may be identified based on geo-location as described in this disclosure. In instances like this, the front end system 204 may provide information to the biometric information server 236, so it can accomplish the requested task. For example, the front end system 204 provides a hash of information from a facial image of an individual for use by the biometric information server 236 in determining if the individual based on information associated with his her facial features does correspond to the identity of the individual linked to the phone.

In other embodiments, a touchpoint or the front end system on behalf of the touchpoints, off-loads one or more touchpoint tasks to the biometric information server. For example, in instances of high throughput the front end system instructs the biometric information server based on information from other biometric capture devices collect biometric information from interconnected freestanding camera for individuals waiting in line for a touchpoint device to assist the touchpoint in identifying individuals, e.g., prescreening individuals to a predetermined threshold to reduce or minimize the time for a touchpoint to obtain biometric information or to minimize instances of non-identification.

The functions, components, and services provided by the front end system can be provided by a distributed computing system (e.g., a collection of computing devices such as the touchpoint devices themselves), a cloud computing system, or the central resource 208. In embodiments, a dedicated front end system can be omitted, and the structures, components, software, processes, and approaches described in conjunction with the front end system 204 can be included in one or more of the touchpoint(s) (e.g., a group of touchpoints such the touchpoints in an airport). In an example, the central resource 208 provides the front end functionality as a virtual machine presented at a touchpoint.

In embodiments, the local environment/front end system/touchpoint are configured to promote rapid/efficient communication in comparison to the communication hardware and approaches taken with respect to other portions of the system or environment. An example of the foregoing is to implement physical communication connections, communication protocols that differ from those implemented between other components in the system/environment. For example, the front end system may push or preload information to one or more touchpoints in anticipation of an event (e.g., 4 hours before a scheduled departure) such as when communication resources become available.

In another example, the central resource preloads information to the front end resource in anticipation of a scheduled or predicted event. In the latter situation, the prediction is made using a computer implemented algorithm (e.g., predictive analytics software) based on one or more current or historic factors that predicts the occurrence of an event. For example, responsive to identification of an impending snowstorm information for individuals traveling from a first airport is communicated to adjacent airports in anticipation that travelers may attempt to travel from the adjacent airport. In another example, information for a passenger traveling through a connecting airport (a layover airport) is forwarded to the connecting airport, if for example it is anticipated that a connecting flight is overbooked, such that the traveler may reroute through the connecting airport to avoid being delayed.

In examples, the front end system 204 issues a unique identifier upon completion of merging information for a given record. Example unique identifiers include, but are not limited to, an electronic receipt with a barcode or other machine readable information, a record number to the individual, an electronic device associated with the individual (e.g., a smartphone), an account for the individual (e.g., an email account), combinations thereof, and so on. For example, the individual's smartphone receives an email with a barcode that when scanned by an optical scanner on an access control device opens the device to permit the individual to pass. The electronic receipt is usable by the system to retrieve at least a portion of the merged information from the record.

The merged information 242 can be approved, authenticated, and/or validated, to associate the information with the unique identifier 248, e.g., an identity token such as a passport, in other instances the merged information 242 can be stored and/or communicated without this having occurred. An example of the latter situation is an individual who merely provided biographic information that is not associated with a unique identifier 248. For example, the traveler fails to provide a passport number associated with a passport that uniquely identifies himself/herself. Other example tokens include identification tokens such as a driver's licenses (whether electronic such as presented on a mobile electronic device), identification credentials, and the like, which can serve as a unique identifier 248.

In embodiments, the record 240 (e.g., travel information) is included in a particular format, stored in a database in memory 224 and/or stored elsewhere in the system 200 (including mirroring on other computing systems). This record format can be the same format, or a colorable version of a record format used by the system, e.g., in a format that facilities data extraction or is forwards/backwards compatible with a record format implemented by the system 200. For example, the information is encoded in UNICODE (Unicode Consortium, Mountain View, Calif.) text format and/or in a particular file format, such as comma delimited file format, also known as comma separated file format or values (CSV). The system 200 in this case can provide a colorable version by communicating at least some of the information in a format that identifies the data contained therein to the system 200.

For example, the information provided by the system complies with extensible markup language (XML) format, a variation thereof, or a like schema, so the system can identify the information based on its defined properties, e.g., XML tags. For example, the name “Charles” has the property of given, or first name, while “Winters,” Charles' last name, has the property last name, or surname. Thus, the system can parse the information into the proper fields in order to make the information usable, minimize the individual's time, and streamline the overall process. The system 200 can implement a variety of protocols to support populating information into a particular structure, e.g., an entry record.

Metadata can be included with the record 240 in order to describe the information. Example metadata includes, but is not limited to, payment method, trip type (e.g., one-way), time of purchase, amount of time prior to trip, location/area where the travel was purchased, IP address of computing device used to make purchase, carrier reward number (frequent flyer number), data entry time, validation checking results (e.g., nature of errors made). Other metadata includes language used by an interface used to consummate purchase, ticket delivery, subsequent travel changes/updates, information regarding other persons in travel party, seat preference, meal preference, purchase history, visa duration, visa issuing location, biometric information, and the like information. Information provided as metadata also can be included itself as other data, e.g., the metadata is included itself in a record 240.

The unique identifier 248, which can function as a session identifier, is added to the record 240 to identify one or more transactions that gave rise to the merged information 242. A common schema can be implemented to substantially ensure security, permit time stamping, identify different versions of the data, and so on.

FIG. 3 is a flow diagram 300 that illustrates implementation of a constraint (e.g., time and/or geo location) in conjunction with information handling disclosed in this document in accordance with one or more embodiments. In embodiments, a constraint is used to limit for example, when or where the information is provided to the system. Other constraints include device type, communication medium (direct wireless v. Internet), input language, and the like discriminators for differentiating information.

A local device (operating independently or as a portion of a system) and other portions of the system 200 can implement constraints. Optionally, a mobile device and the system implement a constraint to limit for example a location or time at which the system receives/accepts information. In examples such as these, location and/or time information is included in the message so the system can limit the information it accepts (e.g., message 302) to that which is provided within the designated time or location. The device can obtain a time and/or location from the message 302 based on the data input 304 and the time stamp 306. In additional embodiments, other system components supply constraint information used in the check. For example, time/location information is obtained from a wireless router in communication with the mobile device that supplied the underlying information.

Optionally, reference information is obtained 312 for use as a basis of comparison for the constraint check 310. In an example, a flight number included in the message functions as a reference for a time associated with the flight number. In another example, an airport code (e.g., DSM) functions as a reference for permitted geolocations within the Des Moines, Iowa airport.

Temporal and/or geo location information is obtained from the message 314. For example, a system performing the method is configured to obtain header information from the message 302 to obtain one or more of time/location from the message 316 or time associated with a touchpoint 318 for use in the constraint check 310.

The constraint information is inspected (320). For example, the information obtained from messages, touchpoints, and other systems is inspected for a timestamp that is used to determine whether or not the time/location is within that permitted by the system. Geolocation information can be used in a similar manner. For example, a system performing the constraint check inspects message header information for geo coordinate information (latitude, longitude) inserted by the mobile device in the packets forming the message to indicate its location. Constraint information is then identified (322) from the other information in the packets.

The device accesses reference temporal and/or geo location information based on the reference information (324). For example, the device uses the reference flight number information from (312) to access the temporal/geo location information from (314). The temporal/geo location information is compared with the reference information (328). For example, a predetermined geo fenced area corresponding to an airport terminal is accessed based on an airport code included in the message.

In another example, a system performing the method consults a registry or lookup table of flight numbers and times to identify when a flight referenced in the message 302 is scheduled to depart 324. In this instance, the flight number from the message is compared 328 to the flight numbers accessed from the lookup table for the matching flight number. The time that corresponds to the flight number can be used as a comparator for time information from the message to determine if the constraint is met. If a corresponding flight number were not located in the lookup table, the process may terminate and issue an error or “no” and shunt the device submitting the message to a human representative.

If the comparison is negative or otherwise not within permissible range 328, the procedure can reject/retry 330 and/or optionally store the outcome 334, and/or send a notification of the outcome (optional; 334) with a fail/final fail (336). If the comparison 328 is positive or otherwise within permissible range, the procedure can store the outcome (optional; 332) and/or notify the outcome (optional; 334) with an acceptance/successful transmission (336).

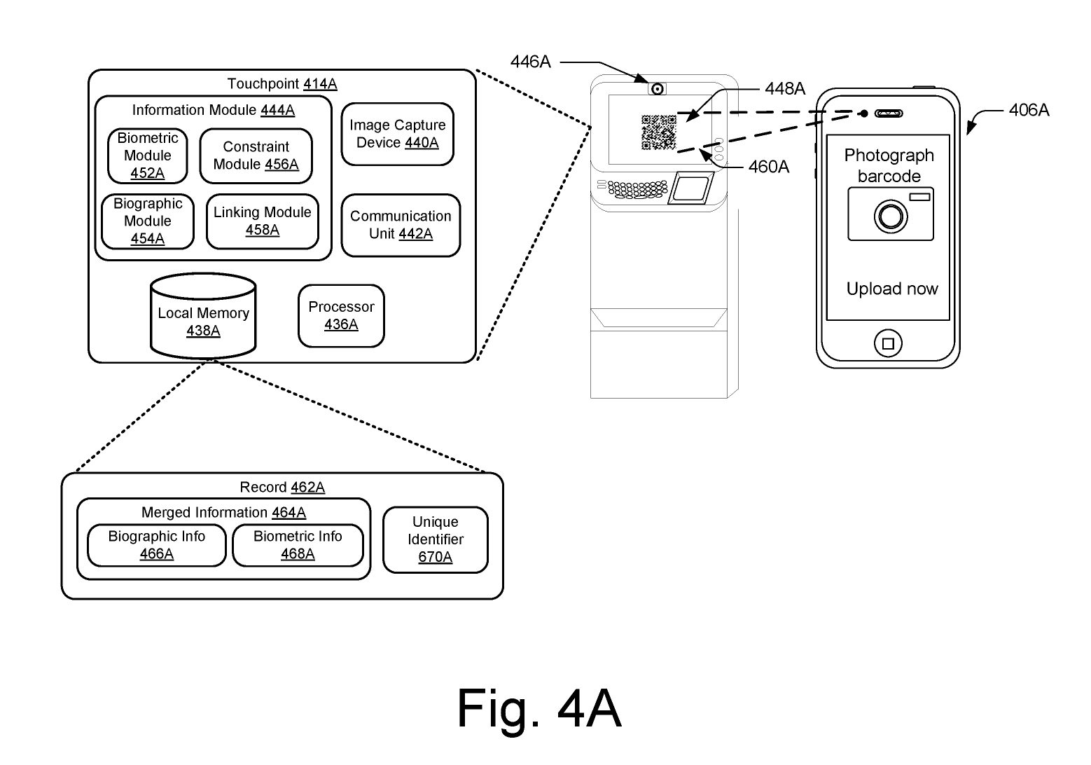

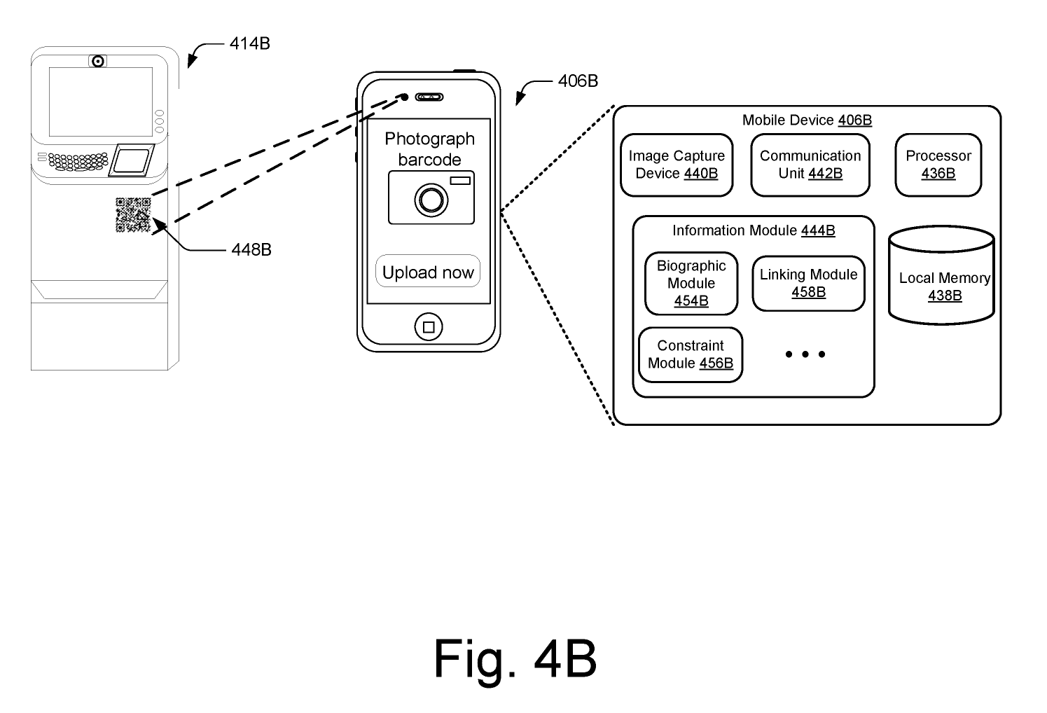

FIG. 4A is a representation of a mobile device 406A capturing linking information 448A, e.g., a two-dimensional barcode, from a display included in a touchpoint 414A in accordance with embodiments of the present disclosure. The mobile device 406A and touchpoint use the linking information 448A so the information collected by the mobile device and touchpoint can be efficiently exchanged and interrelated without the need for manual input/association of the information. For example, the mobile device and system including the touchpoint use the linking information (barcode) to direct and interrelate information entered into the mobile device 406A into association with the information captured by the touchpoint. In this way, for example, biometric information captured by the touchpoint is merged with biographic information input via the mobile device.

The merged information can be stored in memory in a variety of locations, such as local memory 438A included in the touchpoint, memory on the front end or central resource. This way a user can collect information on his/her smartphone before wirelessly communicating it to the touchpoint 414A/front end system/central resource to complete information entry. As illustrated, biographic, information is wirelessly communicated from the mobile device 406A using the information from the barcode to direct/associate it with biometric information entered via the touchpoint so the information is interrelated.

In embodiments, the barcode is usable to retrieve the merged information. For example, an optical scanner scans the barcode output on a display included in the mobile device. In this example, information from the barcode is implemented by for example a computer coupled to the scanner to retrieve at least a portion of the merged information from the memory. In embodiments such as the foregoing, the system uses the barcode information to identify the location of the information in memory. This may be done through use of a registry or implementation of a schema that allows the system to identify the underlying biometric/biographic information.

As illustrated, the touchpoint 414A includes a processor 436A and memory 438A. An image capture device 440A (e.g., a camera) and communication unit 442A are also included. Although a single processor 436A and memory 438A are shown, multiple processors and memory can be included. A wide variety of types and combinations of memory may be employed, such as random access memory (RAM), hard disk memory, removable medium memory, and other types of computer-readable media. The collection device 432A receives information including that information collected by and transmitted from the mobile device 406A.

As further illustrated, the collection device 432A includes an information module 444A. In embodiments, the information module 444A is configured substantially similar to the information module 226, including component modules, described in conjunction with the front end system.

The information module 444A is representative of hardware/software that is constructed to function as described. The information module 444A is a combination of instructions that are useable by the processor 436A to provide the described capabilities and functions, such as when the embodied instructions are executed by the processor. As shown, the information module 444A includes biometric 452A, constraint 456A, biographic 454A and linking 458A modules. While shown and described as individual modules, the hardware/software can be configured as an integrated program of instructions to provide the described functionality, such as through the use of application program interfaces (APIs) that permit individual programs to interface to one or more other programs and provide one or more graphical user interfaces (GUIs) output on a display 460A for user to access/exercise control over the touchpoint.

In an embodiment, the touchpoint 414A is constructed to collect biometric information from included biometric capture devices, such as a camera 446A. While cameras are referenced, a variety of biometric collection devices can be used. Examples include cameras, video cameras, infrared cameras, microphones, motion sensors, electromagnetic sensors, and the like that are constructed to capture biometric information. This is represented as a biometric module 452A, which comprises a combination of hardware and software that is capable of obtaining biometric information or information derived from biometric information.

The biometric module 452A is constructed to compare captured biometric/derived information with reference information (e.g., a gallery of biometric information) to match and/or exclude an individual. For example, the biometric module 452A compares a hash of an iris scan with a gallery of reference iris hashes for a particular flight. The biometric and biographic modules can be constructed to include such information in merged information or in association with the merged information, e.g., linked to or as metadata to information in the merged data.

In some instances, the biometric and biographic modules interface to obtain biographic information to aid or augment biometric comparison. The biographic module 454A can serve as an option to authenticate at least some aspects of an individual's identity. For instance, prior to the touchpoint finally rejecting an individual as a non-match or commencing an exclusion comparison, it may place an ad hoc request for the biometric module 452A to biometrically identify the individual. If the biometric module 452A is not able to positively identify the individual to a predetermined threshold, the biographic module 454A can retrieve biographic information from local memory or the central resource for use in questioning the individual, e.g., mother's maiden name, middle initial of a sibling, and the like. If the individual is unable to answer the biographic questions, the biometric module 452A can commence determining if the individual is to be excluded, e.g., on a banned list. In contrast, the biometric module 454A may obtain additional biometric information from the individual for comparison if the individual correctly answers the biographic questions. This may be of the same type of biometric information or of a different mode, e.g., iris. In some embodiments, instead of the biometric module attempting to identify the individual, the information module 444A is configured to proceed with providing biographic information for use in questioning the individual via a GUI output on a display.

In another example, the biometric module 452A locks out a reference identity if an individual assert the identity. For example, the touchpoint 414A communicates to other touchpoints in its community that the record for Charles Winters is locked because a user is attempting to assert it as a basis of identification. This “lockout” may be temporary (e.g., for a set time, until the occurrence of an event (no match)) or until the individual is checked out of the system, e.g., boards a vehicle, leaves his/her final destination. This lockout prevents other touchpoints from using “Charles Winters” as a basis of identification. This lockout may result from user input or by scanning a barcode output on mobile device display.

Information associated with one or more of the lock out, initial comparison, final comparison and so forth may be stored in or associated with an identity record 240 or in a temporary register, such as in memory 438A or other memory associated with the system. The foregoing includes information derived from the collected/generated management information, e.g., a facial hash.

The biometric module 452A can be configured to manage tasks among the touchpoints in a collaborative manner. For example, the biometric module 452A, functioning as a cloud type local resource, together with other touchpoints manages their collective operation to maintain a specified throughput or average time for the overall group. For example, the biometric module 452A changes the procedures implemented by the various touchpoints on a consensus basis.

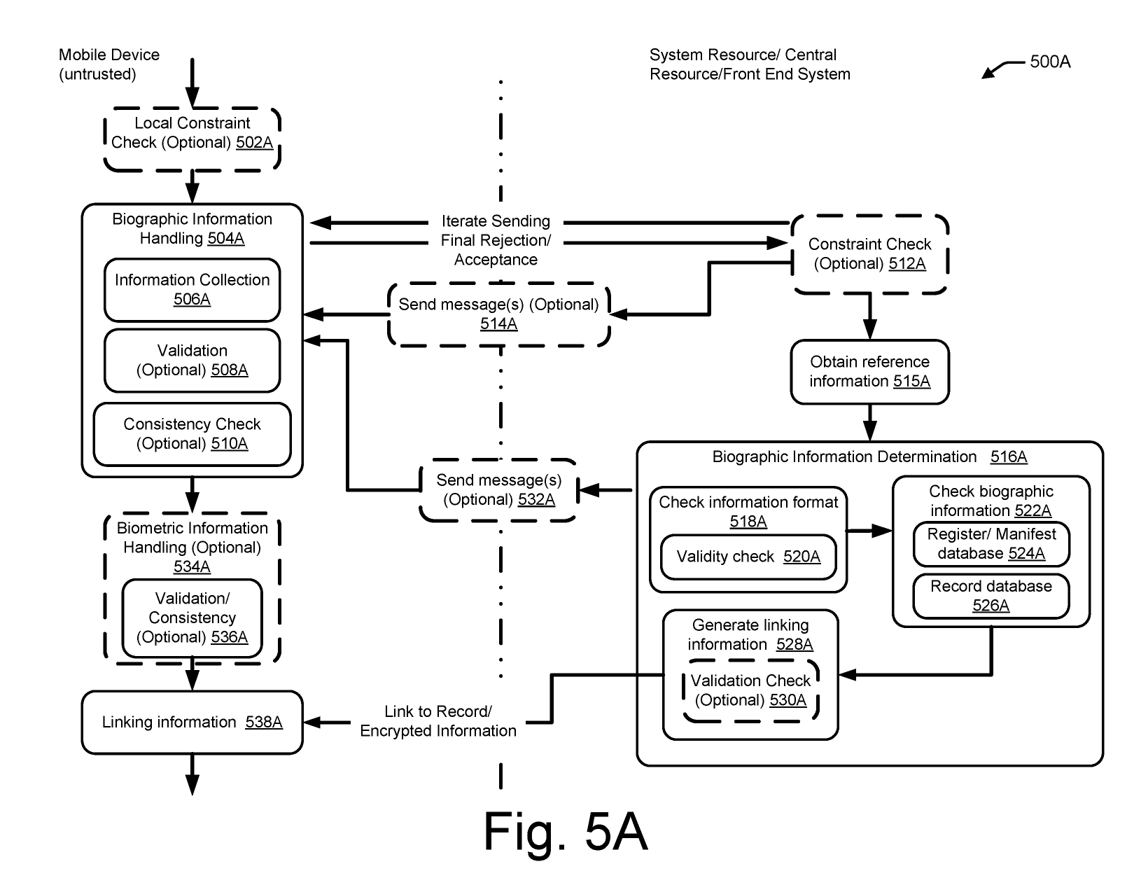

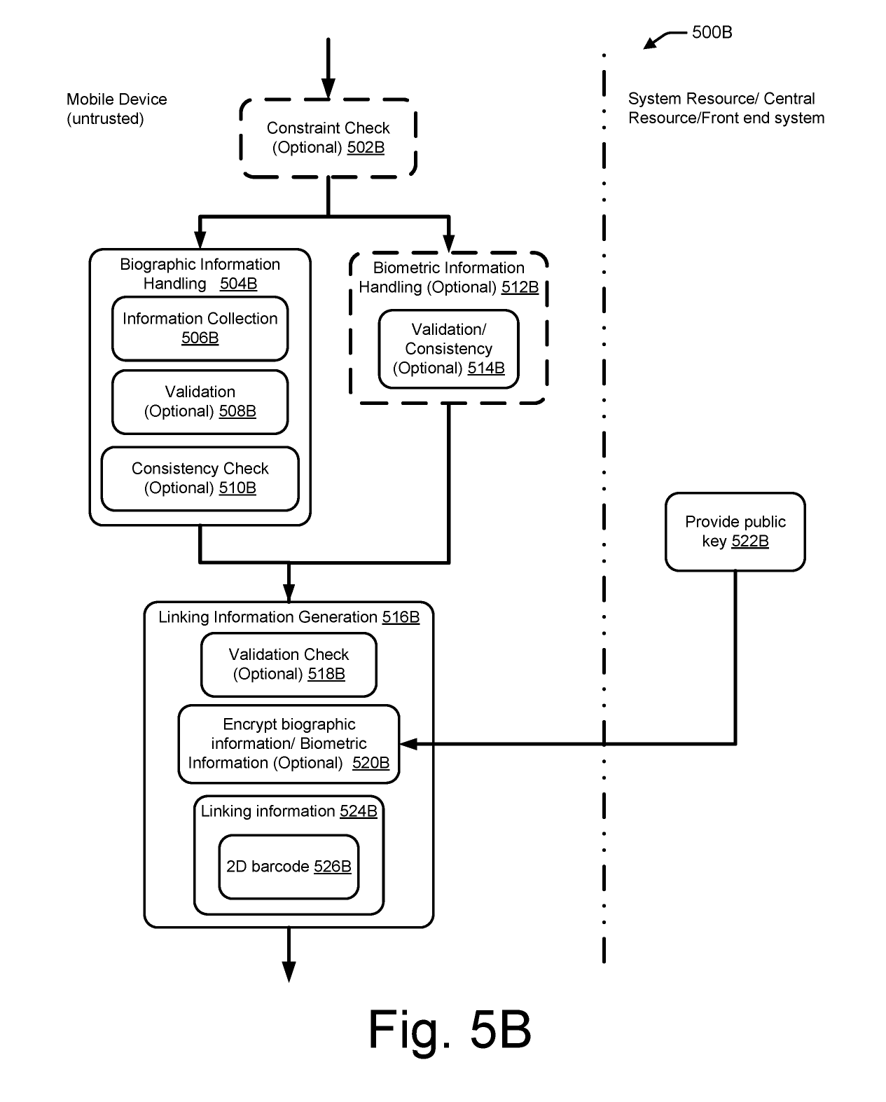

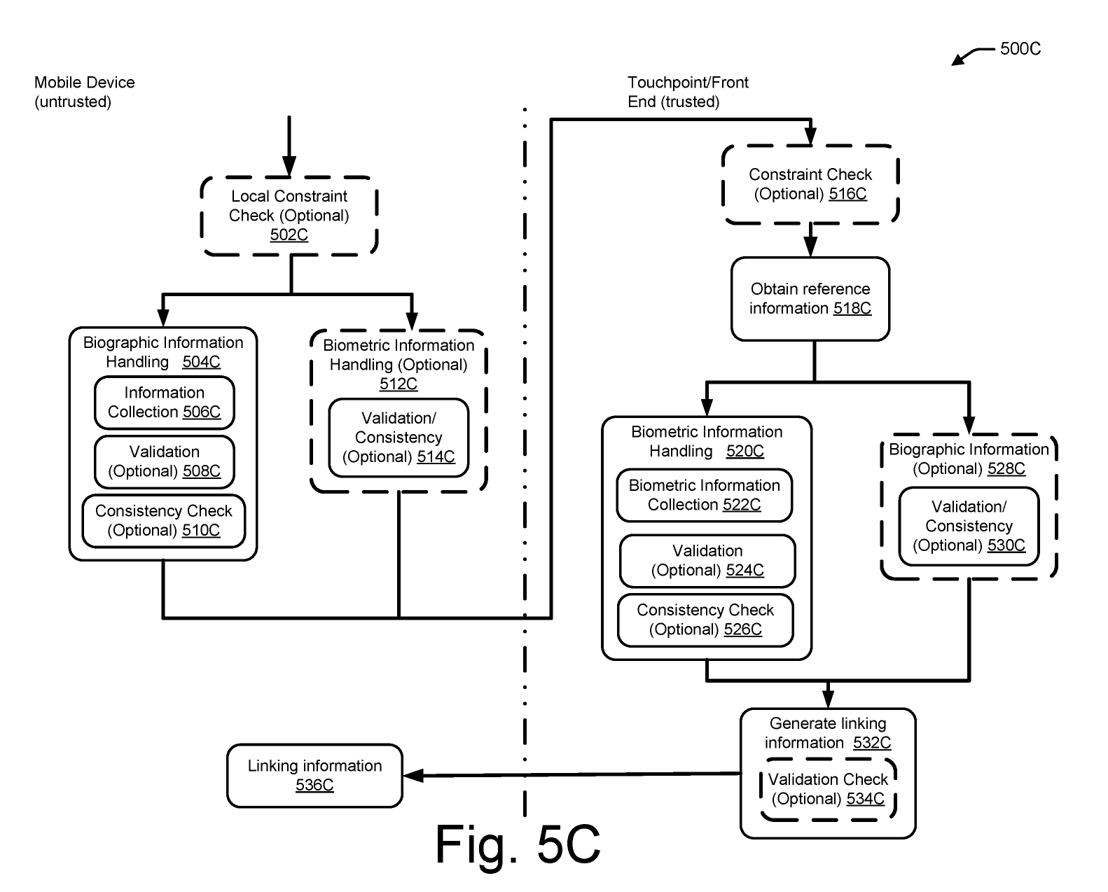

As additionally shown, the information module 444A includes a constraint module 456A. The constraint module 456A like the other modules is constructed with supporting hardware/software to impose one or more constraints on information provided/attempted to be provided to the touchpoint or the system e.g., the front end system, central resource. For example, the constraint module 456A reviews packet header information to determine whether it meets a predetermined constraint, e.g., within a timeframe window, a predetermined geographic area, and so on such as that described with respect to the front end system and in conjunction with FIGS. 3 and 5A-5C, below. In embodiments, the constraint module included in the touchpoint is constructed and functions substantially similar to the constraint module 230 included in the front end system 204. The constraint module 456A can be configured based on design or operational preference.

As further illustrated in FIG. 4A, the touchpoint's information module 444A includes a biographic module 454A that is representative of functionality and corresponding hardware/software to support the collection, handling, updating, or processing of biographic information. Biographic information can be supplied via a mobile device 406A, from the central resource 208, or front end system 204. For example, the biographic module 444A is constructed to compare biographic information supplied by a user's mobile device with pre-existing or reference biographic information to determine if any information has changed (address change) and so on. In another example, the biographic module 444A, upon determining supplied information does not match that for an asserted identity, it can flag the individual for different biometric procedures, for biometric exclusion comparison, and so forth.

In embodiments, the biographic module 444A obtains record information from a front end system or central resource, and indexes the information from the records according to biographic information to minimize system resources used for biometric identification/exclusion. The foregoing can be done via the biographic module 454A requesting information or the front end system/central resource pushing the information for storage in local memory 438A. The biometric information (e.g., hashes of facial images) can be indexed based on associated biographic information such as name, passport number, and/or flight number, to minimize the computing resources in comparison to not organizing the information based on related biographic information.

As illustrated, the local memory 438A can store a record 462A including merged information 464A and unique identifier 670A for a transaction, e.g., an identification event. Local memory 438A for the touchpoint also can store a copy of an electronic receipt 672A for the transaction. The merged information 464A in embodiments include biographic information 466A and/or biometric information 468A. In some instances, the biographic/biometric information (and/or record 462A) is stored in local memory 438A prior to anticipated use by the touchpoint. Then as individuals present themselves for identification, the biographic module 454A uses the biographic information at least at first to down select which biometric information is to be used for reference. For example, in response to a user inputting a passport number or asserting an identity via a 2D barcode, the biographic module retrieves at least a portion of the biographic and biometric information from memory 438A for the individual associated with that passport number. The biographic module may flag the record/identity in local memory to prevent the biometric module or the touchpoints from using the identity/record until an identification determination is complete. In some embodiments, the biographic module communicates the lock/flag to one or more of the front end system or central resource to prevent the record/identity from being used as a reference for identification until it is released by the touchpoint 414A. In embodiments, the biographic module 454A manages biographic information in local memory 438A.

Still referring to FIG. 4A, as can be seen the information module 444A includes a linking module 458A that is representative of functionality and corresponding hardware/software to merge information from the touchpoint and in this example the mobile device 414A. As noted in the overview and discussion of the linking module 234 from the front end system, this may be done in a variety of ways with one device providing linking information that is scanned by another device so that information from the scanning device can be linked to corresponding information generated or received by the device providing the linking information. In embodiments, linking information (directly) represents the information, such as an encoded version of the user's information. In embodiments the linking module includes a record number or other unique identifier 670A used to reference the merged information in memory, e.g., local memory on the touchpoint or front end system or on the central resource. The foregoing may be done based on a common record number or schema.

Like the linking module included in the front end system, the linking module 458A can use the linking information to locate the relevant information in memory. For example, linking information identifies a registry entry that in-turn indicates where the information is stored in physical memory, whether locally or in memory associated with the central resource. In some instances, merged information is accessed/retrieved by the touchpoint scanning a user's mobile phone for a barcode output on a display as generally illustrated in FIG. 1.

In the example illustrated in FIG. 4A, the touchpoint or the front end/central resource on its behalf can link the information collected by the touchpoint (e.g., biometric information) with information collected by the mobile device 406A. For example, prior to arriving for security screening an individual may use his/her smartphone to collect responses (answers) to border control questions, such as those on U.S. Customs and Border Protection Declaration Form 6059B. The linking module may use information from the barcode when communicating the answers to the system including touchpoint so it the answers are merged with the information collected by the touchpoint. In this way the touchpoint or the front end system or central system on its behalf are made aware that the provided answers are associated with the information collected by the touchpoint without manually input.

FIG. 4B is a pictorial representation of a mobile device 406B capturing linking information 448B, e.g., a two-dimensional barcode, affixed to a touchpoint 414B in accordance with embodiments of the present disclosure. The linking information 448B enables the mobile device 406B to supply information to the system (e.g., the touchpoint 414B or front end system) without having to manually enter information to associate it together. In embodiments, the mobile device 406B includes modular information design (444B) similar to that of the touchpoints and front end system. For example, the information module 444B includes biographic, linking, and constraint modules for, respectively, accepting and locally checking biographic information, routing mobile device supplied information for merging with touchpoint collected information, and locally checking whether a constraint is met. An example of the latter is the constraint module accessing the Internet to determine whether submission of information is within a permitted timeframe before permitting the user to submit information for an upcoming event, e.g. a test, a flight. Those of skill in the art will appreciate that that the biometric module functionality may not be included in an information module 444B included in the mobile device if it is untrusted or substantially untrusted.

In the illustrated example, the mobile device 406B captures the linking information 448B to enable the mobile device 406B to transfer collected information (e.g., biographic information). Such information can be transferred to the touchpoint 414B, or other portion of the system.

Rather than generate and display the linking information 448B as a graphical element, the touchpoint 414B can carries it as a static printed image, e.g., an image of the barcode that can be imaged using an image capture device 440B. The linking information 448B in this embodiment represent a unique identifier that corresponds to the touchpoint 414B, such as a serial number, kiosk number, unique interne address, unique wireless network address, or the like. Accordingly, the mobile device 406B can establish communication with the touchpoint 414B (either directly or indirectly) in order to transfer mobile device 406B captured information to the touchpoint 414B, the front end system, or the central resource for merging with information collected or captured by the touchpoint 414B.

Example Methods

FIGS. 5A-5C illustrate sample data flows in conjunction with hardware/software in accordance with this disclosure. The following discussion describes procedures that may be implemented utilizing the previously described systems, techniques, approaches, and devices. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. As illustrated, the data flows 500A involve a mobile device (untrusted), as well as a system resource/central resource/front end system. The illustrated vertical line of dots and dashes represents a trust boundary. In portions of the following discussion, reference will be made to the environment 200 of FIG. 2 and the systems, devices, modules, applications, algorithms, approaches, and techniques (including those of FIGS. 1, 3, 4A, 4B, and 6) described above and below. While some block/decisions are captioned as “optional,” there is to be no negative inference with respect blocks/decisions that are not denominated as “optional,” i.e., the blocks/decisions are not “mandatory.” In accordance with some embodiments, information is stored in memory (at least temporarily) during performance of the methods for a variety of reasons. Example rationales as to whether an element is optional include, but are not limited to, data processing convenience, communication convenience, permit batch validation/review, records maintenance, and so on, and combinations thereof

Turning to FIG. 5A, a flow diagram 500A illustrates steps in a process for handling biographic and biometric information, constraint checking, biographic information determination, and linking information. For example, the method 500A is used to merge biographic/biometric information from a mobile device (untrusted) with reference information from a system resource/central resource/front end system, based on linking information, while performing a constraint check. The steps can be implemented in connection with any suitable hardware, software, programs, scripts, firmware or combination thereof. In at least some embodiments, the method can be implemented in software by such as described above. As illustrated, some steps are positioned to the left, representing steps by a mobile device (untrusted), some steps are positioned to the middle, representing steps between the mobile device and a system resource/central resource/front end system, and some steps are positioned to the right, representing steps by the system resource/central resource/front end system.

The method 500A can initiate in a variety of ways. Example initiation events include, but are not limited to an individual scanning a passport or boarding ticket or a person purchasing a travel ticket using a third-party system in anticipation of travel, or the person arriving within a geographic location, or the arrival of a predetermined time period corresponding to predetermined travel plans/purchased tickets. Initiation can involve pre-steps in which information is input or otherwise obtained by a mobile device that indicate an individual will be traveling and/or is at a geographic location, such as passing through customs. An example initiation event is an individual obtaining a ticket that, if used, would cause him/her to pass through customs. In other instance, initiation occurs is in response to the person interacting with a system, such as the system described with reference to FIG. 2.

The mobile device (untrusted) can perform a local constraint check (optional; 502A). For example, the mobile device can check its onboard GPS location, and/or its local time, to identify whether the local information indicated by the mobile device corresponds to that permitted according to the ticket (e.g., check whether the mobile device's time is within 4 (four) hours of departure time for a purchased ticket, and/or check whether the mobile's GPS location is within the departure airport corresponding to the purchased ticket).

In an embodiment, the mobile device performs biographic information handling (504A), which involves information collection (506A), validation (optional; 508A), and consistency check (optional; 510A).

Information can be collected (506A) in a variety of ways. Information can be obtained directly from the individual or indirectly by accessing information from a resource, e.g., user information kept in a profile on a smartphone. Information collection in embodiments is performed responsive to an initiating event such as individual submitting answers to border control questions via his/her smartphone. Although this can be done at a departure facility, it can be done prior to arrival at departure location by a person providing the information online to, for example, via the Internet.

Direct information collection can include an individual typing information into his/her mobile device and so on. As part of traveling internationally for instance, a person types in biographic information such as travel information. In some examples, the information is stored in memory on the mobile device, such as in travel application, or app. Available information can be pre-populated so the person can avoid entering information that is already in or available to the system.

The application in embodiments supports one or more GUIs for collecting information via text boxes, check boxes, radio buttons, calendar selectors, and so forth. The information can be validated (optional; 508A) by the mobile device. For example, the user can input information about a departure airport, and the mobile device can validate that it is consistent with a location represented in a travel registration. The information also can be checked for consistency (optional; 510A) at the mobile device. For example, the mobile device can run a mobile spell checking module to parse text entries on the mobile device to check for misspellings or other typographical issues.

The collected information can be iteratively sent/rejected/resent between the mobile device and the system resource/central resource/front end system, e.g., based on performing a constraint check (optional; 512A). Status and/or outcome of the constraint check 512A can be communicated to the mobile device by sending message(s) (optional; 514A). For example, the system can check the collected information from the mobile device for a valid departure city, and send a message to the mobile device that the collected departure city is incorrect because it does not exist.

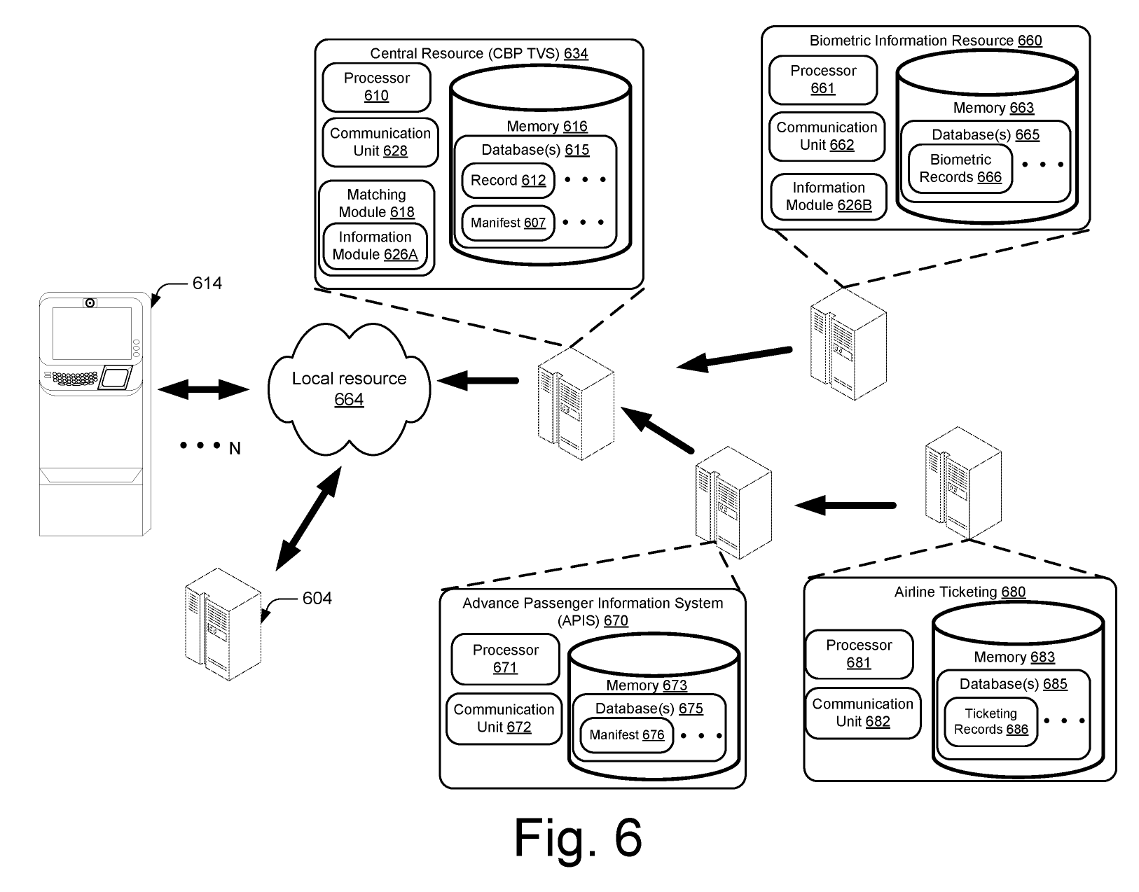

The system obtains reference information (515A). Such reference information can be obtained from various sources, in order to check the collected information from the mobile device. In an embodiment, entry of collected information causes a central resource system to communicate with other systems, e.g., a ships travel database or other systems (e.g., see the various resources of FIG. 6 that can intercommunicate), to obtain other passenger information (indirect information collection) which may include biographic and/or biometric information for vetting, validating, or otherwise checking the collected information.

In some instances, obtaining reference information 515A includes converting the information from one format to another. An example of this scenario includes converting an image from a postscript file format portable document format (PDF, Adobe Systems, Inc., San Jose, Calif.) to a JPEG format so the image is understandable by the system or the system implements a common format. Information can be indirectly collected by decoding information that is encoded in machine readable media (e.g., on a magnetic strip) or information encoded in an optically readable identifier.

The system can then perform biographic information determination (516A) on the obtained reference information (515A), and send messages(s) (optional; 532A) to report a result of the biographic information determination (516A). The biographic information determination (516A) includes checking information format (518A) which includes validity check (520A). Example information format and validity checks include validating information, confirming information is correctly formatted and/or accurate, and confirming information for a current event is accurate to historical information if historical information is available for comparison. These checks can be triggered responsive to an event. For example, a validity check is performed responsive to an individual submitting his/her biographic information on the mobile device.

The system checks biographic information 522A, which may include checking the collected information 506A against obtained reference information 514A to determine whether the collected information 506A is accurate. An example of the foregoing, is the central resource checking an entered given and surname against those in a register/flight manifest database (524A), to ensure the information matches. Checking biographic information (522A) also can involve comparing collected information with information in a record database (526A), such as information that is of a sufficient difference in time from reference information in the record database (526A) to indicate that the collected information is likely accurate. Such checks can be performed as a matter of routine or upon an event such as a determination that biographic information does not match to a predetermined level or the biographic information matches or likely matches biographic information meeting a predetermined criterion (not permitted to fly). Different components can perform the various checks. For example, the central resource handles format (518A) and validity (520A)/accuracy checks, while consistency (510A) is handled by or at least partially handled by a collection device such as the app on the mobile device. In performing such checks, an indication of the outcome can be maintained with the information itself (e.g., a validation ID) and/or in a separate data structure for this purpose. In some instances, the central resource maintains a table or separate database of such checks, and messages (532A) can be used to inform the device/user of the status of the checks.

Following the checks of the biographic information determination (516A), the system can generate linking information (528A). An optional validation check (optional; 530A) can be applied to ensure the linking information is valid. As an example, the linking information can be a 2D barcode generated as an image. The validation check (530A) can be used to internally scan the generated 2D barcode to ensure it links to the intended information. The generated linking information is then sent to the mobile device as linking information (538A). The mobile device can then use the linking information to access the merged collected information (506A) and/or obtained reference information (514A).

Turning to FIG. 5B, a flow diagram 500B illustrates steps in a process for handling (optional) constraint check(s) on biographic and biometric information, generating linking information, and optionally encrypting information using a public key. The steps can be implemented in connection with any suitable hardware, software, programs, scripts, firmware or combination thereof. In at least some embodiments, the method can be implemented in software by such as described above. As illustrated, some steps are positioned to the left, representing those performed by a mobile device (untrusted), and some steps are positioned to the right, representing those performed by system resources/central resource/front end system. The constraint check (optional; 502B) includes, for example, the mobile device accessing its GPS coordinates or mobile clock to serve as device information, temporal/geolocation information. The device information can be compared with reference information to check whether the device information is within the constraints of the reference information. For example, a predetermined geo fenced area is downloaded by and stored in memory of the mobile device as reference information, and the geo location information obtained from sensors of the mobile device is compared with the stored reference information to identify whether the mobile device is within bounds of the geo fenced area. Accordingly, the constraint check (502B) can tell whether an individual using the mobile device is located in a predetermined location, such as local environment 202 illustrated in FIG. 2.

The biographic information handling (504B) and biometric information handling (optional; 512B) involve validation and/or consistency steps (508B), (510B), and (514B). Biographic information collection (506B) can involve the user typing information into a mobile device. The mobile device is configured to validate and/or check the consistency of biographic information to determine whether, e.g., data entered in a text box is valid (e.g., numbers and not alphabetic characters are entered into a zip code text box), and is consistent (e.g., five numeric digits correspond to an actual zip code, without missing digits). Example validation/consistency outcomes include, valid and/or passed review (an affirmative outcome); not valid and/or did not pass review (a negative outcome, generally a failed outcome and optional notification). An example situation involves a zip code text box entry being valid (includes numbers), but the numbers do not correspond to a recognized zip code (inconsistent). In scenarios that result in a not valid, no pass, or ambiguous outcomes, a record can be generated that notes the determination (non-validation or review failure), stores relevant data, and so forth. An alert, an error message, or a message that facilitates corrective action can be displayed by the mobile device.

Such example validation and consistency checking can also be applied by the mobile device to biometric information (514B). For example, the mobile device can check a collected fingerprint to determine that it (to an appropriate predetermined level) corresponds to a valid type of fingerprint, e.g., loop, whorl, or arch, and the fingerprint is sufficiently identifiable, e.g., so as to permit accurate matching against a database to be accessed online. Additional types of validation and/or consistency checking include checking the biometric information against online repositories of such information, e.g., the Integrated Automated Fingerprint Identification System (IAFIS), maintained by the Federal Bureau of Investigation (FBI).

The biographic and/or biometric information is used to generate linking information (516B). As discussed above, linking information (e.g., the 2D barcode) is usable by the system including its components to exchange, relate, or access information so the system can merge information (e.g. biographic/biometric information) obtained from different resources, including resources associated with different trust levels. Linking information may be the information encoded into machine readable format (and likely encrypted as well) or a link to the information, e.g., location of the related information in memory.

A validation check (optional; 518B) can be performed on the linking information. In an embodiment, the linking information is presented as a Uniform Resource Locator (URL) for a website, which is encoded as a machine-readable 2D barcode. The system can check whether the URL is valid by attempting to visit the corresponding website address, and can check whether the barcode is valid by optically confirming that the generated 2D barcode is a valid representation of the URL.

The biographic information/biometric information is encrypted (optional; 520B). The linking information itself can be of a format, such as a URL, that is amenable to encryption. For example, the text of the URL can be encrypted, thereby obfuscating the URL from unwanted parties even if a 2D barcode reader is used to intercept the 2D barcode and decode its contents to obtain the encrypted URL. Furthermore, the underlying biographic/biometric information can be encrypted, independent of whether the linking information is also encrypted. For example, an individual's personal address information can be represented as a text string, which is then encrypted. The encrypted text string can then be encoded as linking information, such as a 2D barcode. In other embodiments, the underlying information can be encrypted and stored remotely, and the linking information is provided as a link to access the encrypted information at the remote storage location. The system can use various forms of encryption, including public-private key encryption, with appropriate hardware/software (and key information) to obtain or access the data. The system can use an application program interface (API) that implements an encryption/decryption algorithm (e.g., PKI type encryption) that when executed by a computing device is able to access or discern the underlying information embodied in the barcode. As illustrated, the encryption can make use of a public key provided (522B) by the system resource/central resource/front end system.

The linking information (524B) is generated, which pertains to the biographic and/or biometric information that is optionally validated and/or encrypted. As illustrated, a 2D barcode (526B) is used to represent the linking information (524B).

Turning to FIG. 5C, a flow diagram 500C illustrates steps in a process for handling (optional) local and/or touchpoint/front end constraint check(s) on biographic and biometric information, and generating linking information. The steps can be implemented in connection with suitable hardware, software, programs, scripts, firmware or combination thereof. In at least some embodiments, the method can be implemented in software by such as described above. As illustrated, some steps are positioned to the left, representing those for example performed by a mobile device (untrusted), and some are positioned to the right, representing steps by the touchpoint/front end (trusted).

The local constraint check (optional; 502C) includes, for example, the mobile device accessing its GPS coordinates or mobile clock to serve as device information, such as temporal/geo location information. The device information can be compared with reference information to check whether the device information is within the constraints of the reference information. For example, the mobile device downloads and stores, locally in memory of the mobile device, a predetermined geo fenced area as reference information, and locally obtains from sensors of the mobile device the geo location information of the mobile device, and the mobile device performs a local comparison of the information to identify whether the mobile device is within bounds of the geo fenced area. Accordingly, the constraint check (502C) can tell whether an individual using the mobile device is located in a given local environment, such as local environment 202 illustrated in FIG. 2.

The biographic information handling (504C) and biometric information handling (optional; 512C) involve validation and/or consistency steps (508C), (510C), and (514C). Biographic information collection (506C) can involve the user typing information into a mobile device. The mobile device is configured to validate and/or check the consistency of biographic information to determine whether, e.g., data entered in a text box is valid (e.g., numbers and not alphabetic characters are entered into a zip code text box), and is consistent (e.g., five numeric digits correspond to an actual zip code, without missing digits). Example validation/consistency outcomes include, valid and/or passed review (an affirmative outcome); not valid and/or did not pass review (a negative outcome, generally a failed outcome and optional notification). An example situation involves, for example, a zip code text box entry being valid (includes numbers), but the numbers do not correspond to a recognized zip code (inconsistent). In scenarios that result in a not valid, no pass, or ambiguous outcomes, a record can be generated that notes the determination (non-validation or review failure), stores relevant data, and so forth. An alert, an error message, or a message that facilitates corrective action can be displayed by the mobile device.

Such example validation and consistency checking can also be applied by the mobile device to biometric information (514C). For example, the mobile device can analyze, using the mobile device's processing resources, a collected fingerprint to determine that it (to an appropriate predetermined level) corresponds to a valid type of fingerprint, e.g., loop, whorl, or arch, and the fingerprint is sufficiently identifiable, e.g., so as to permit accurate matching against a database to be accessed online. Additional types of validation and/or consistency checking include checking the biometric information by downloading a working, local subset of information from online repositories of such information, e.g., the Integrated Automated Fingerprint Identification System (IAFIS), maintained by the Federal Bureau of Investigation (FBI).

Similar to such local constraint checking and information handling that can be performed by the mobile device, the touchpoint/front end also can perform a constraint check (optional; 516C), biometric information handling (520C), and biographic information handling (optional; 528C), in addition to obtaining reference information (518C).

The constraint check (optional; 516C) includes, for example, the touchpoint checking the information provided by the mobile device. The information can be compared with constraint information obtained by the touchpoint, to check whether the device information corresponds to any constraints. For example, the touchpoint provides GPS coordinates pertaining to where the touchpoint is geographically located, or provides a network clock time to serve as device information, temporal/geo location information. The touchpoint can store a predetermined geo fenced area to compare against the GPS coordinates provided by the mobile device. Accordingly, the constraint check (optional; 516C) can cross-check whether an individual using the mobile device is located in a given local environment, such as local environment 202 illustrated in FIG. 2.

The touchpoint can obtain reference information (518C), is usable to check against the collected information (506C) from the mobile device. For example, the touchpoint can access a database of registered flier addresses, to use as a reference as to whether a collected biographic address is included within the database.

The biometric information handling (520C) and biographic information handling (optional; 528C) involve validation and/or consistency steps (524C), (526C), and (530C). Biometric information collection (522C) can involve the user submitting to collection, by the touchpoint, of biometric information into a biometric collection device of the touchpoint.

Validation (optional; 524C) and consistency (optional; 526C) checking can be applied by the touchpoint device to biometric information (520C). For example, the touchpoint can analyze a collected fingerprint to determine that it (to an appropriate predetermined level) corresponds to a valid type of fingerprint, e.g., loop, whorl, or arch, and the fingerprint is sufficiently identifiable, e.g., so as to permit accurate matching against a database to be accessed online (e.g., the obtained reference information (518C)). Additional types of validation and/or consistency checking include checking the biometric information against online repositories of such information, e.g., the Integrated Automated Fingerprint Identification System (IAFIS), maintained by the Federal Bureau of Investigation (FBI).

The touchpoint is configured to validate and/or check the consistency of biographic information (528C) to determine whether, e.g., data entered in a text box is valid (e.g., numbers and not alphabetic characters are entered into a zip code text box), and is consistent (e.g., five numeric digits correspond to an actual zip code, without missing digits). Example validation/consistency outcomes include valid and/or passed review (an affirmative outcome), and not valid and/or did not pass review (a negative outcome, generally a failed outcome and optional notification). An example situation involves, for example, a zip code text box entry being found valid (includes numbers), but the numbers do not correspond to a recognized zip code (and the entry is therefore inconsistent). In scenarios that result in a not valid, no pass, or ambiguous outcomes, a record can be generated that notes the determination (non-validation or review failure), stores relevant data, and so forth. An alert, an error message, or a message that facilitates corrective action can be displayed by the mobile device.

The biographic and/or biometric information is used to generate linking information (532C). As discussed above, linking information (e.g., the 2D barcode) is usable by the system including its components to exchange, relate, or access information so the system can merge information (e.g. biographic/biometric information) obtained from different resources, including resources associated with different trust levels. Linking information may be the information encoded into machine readable format (and can be encrypted as well) or may be a link to the information, e.g., location of the related information in memory.

A validation check (optional; 534C) can be performed on the linking information. In an embodiment, the linking information is presented as a Uniform Resource Locator (URL) for a website, which is encoded as a machine-readable 2D barcode. The system can check whether the URL is valid by attempting to visit the corresponding website address, and can check whether the barcode is valid by optically confirming that the generated 2D barcode is a valid representation of the URL.

The generated linking information 532C from the touchpoint can then be sent to the mobile device as linking information 536C. In an embodiment, the touchpoint can transfer a digital image to the mobile device via an email, via a Multimedia Messaging Service (MMS), or other networking or optical transmission medium (e.g., the touchpoint can visually display the linking information on a screen of the touchpoint, and the mobile device can photograph the linking information).

Information Positioning

FIG. 6 illustrates a resource configuration including third-party resources that can be implemented in conjunction with the devices, systems, methods, approaches, and techniques disclosed herein. The central resource 634, shown as Customs and Border Protection Traveler Verification Service (TVS), is illustrative of functionality and corresponding hardware/software to support a local resource 664 (illustrated as a localized cloud service) that supports one or more touchpoints. The central resource (illustrated as server 634) is shown as being a supported by a biometric information resource (illustrated as a server 660), an advanced passenger information system (APIS) resource (illustrated as a server 670), and an airline ticketing resource (illustrated as a server 680). It is to be apparent that the various resources can provide the described functionality and may be embodied as a combination of hardware and/or software. In embodiments, the various resources 660, 670, 680 can be co-located with the central resource 634, although in other examples, the resources can be remotely located relative to the central resource and/or the other resources 660, 670, 680. While the various resources are shown with arrows indicating sample data flows, those of skill in the art will appreciate that the servers may be communicatively coupled via a variety of mediums such as a dedicated network, a semi-dedicated network, the Internet, and so forth. It is also to be apparent that the function of the various resource may be provided via a cloud type hardware/software arrangement. And, although directional arrows are used in the illustration the communication can be two-way such that data is pushed/retrieved (pulled) to/from the various physical devices based on configuration and design choice as understood by one of ordinary skill in the art.

In some embodiments, the central resource functions as a gatekeeper by maintaining comparatively high or different security on the central resource, local resource, biometric resource (which may be provided by a third party such as a state department of motor vehicles or an association of department of motor vehicles) and touchpoints, in relation to a comparatively lower or different security schema applied by the APIS 670, and airline ticketing resources. The central resource 634 in embodiments can store, obtain/validate information, coordinate information, match records, link information, and combinations thereof on behalf of the local resource and touchpoints.

For example, responsive to a determination that the biometric resource does not have a reference image or signature, the central resource or biometric resource may request the information and any other information (biographic/biometric) from another resource such as a state department of motor vehicles database system. Such DMV databases may be operated by or implement a variety of commercial software, hardware and may be virtualized as a cloud type resource. Those of skill in the art will appreciate that such information may be protected using a variety of security methodologies including, but not limited to, public/private key encryption (public key encryption (PKI)), virtual private network communication or the like to protect information.

In embodiments, the central resource 634 includes one or more computing systems constructed to provide central resource functionality. In implementations where multiple computing resources are implemented, individual ones may operate in a redundant fashion, perform load balancing, handling of processor/memory interrupts, and so forth to provide substantially seamless support to the one or more predetermined local environments (e.g., the front end system and touchpoints). Redundant support and/or load balancing between multiple computing resources can be handled in a variety of ways. In some instances, different systems can apportion different tasks or portions of tasks among themselves, while in other respective central resources accept/hand-off tasks as the individual computing systems become relatively busy/become less busy. For example, rather than hashing a raw image or matching a hash of an image to hashes of images included in a gallery, the central resource can instruct the biometric resource to perform this task on its behalf or on behalf of a touchpoint, front end system, or local resource. In additional embodiments, components or functions performed by the central resource 634 may be performed or partially by a computing resource located in a local environment, such as at an airport, port, customs facility, port-of-entry, test facility, department of motor vehicles office, and so forth. In some scenarios, the central resource and the local resource may apportion responsibilities and tasks according to a predetermined algorithm.

For example, while in typical operation the central resource functions as a master by controlling (to at least some extent) the local resource 664 or front end system (such as that described with respect to FIG. 2), in some instances the local resource can take control (or at least partially take control) of the central resource or some function or aspect of the central resource, e.g., memory access. An example of the foregoing is the local resource controlling or directing the central resource to set a flag to lock a record due to an unanticipated assertion of an identity such as due to “last minute” travel plans. In this situation, the local resource can instruct the central resource to lock out the record corresponding to the asserted identity by flagging the record. In this instance, the local resource can pull at least a portion of the information (biometric/biographic) from the central resource and/or biometric resource to support matching, exclusion, or providing information. Other resources may be accessed as well for information.

For example, responsive to a determination that an identification token is suspect, the central resource can query a state DMV database to determine a date associated with its electronic record and/or the token itself (e.g., driver's license). An electronic record and/or token with an older date may be accorded a greater level of trust (compared to a predetermined threshold). In an embodiment, responsive to a determination, by for example the central resource, that a proffered driver's license is “new” due to an original license being lost, stolen, or destroyed, the central resource, the central resource may apply a higher biometric identification threshold in comparison to that which it usually implements or apply a different algorithm, instruct touchpoints/biometric capture devices to obtain additional or comparatively more detailed biometric information than that obtained if the token was not identified as being new.

It should be apparent that multiple local resources can collaborative make use of/take control of the central resource based on a predetermined algorithm that implements one or more resource management approaches including, but not limited to, round robin, first in first out, a weighted average importance methodology, and so forth for controlling, managing, or using the central resource.

The touchpoint 614 and central resource 634 can communicate in a web-enabled manner and supported by a cloud type local resource supported by one or more physical devices, such as server 604 or the touchpoints themselves, e.g., touchpoints 614 through “N.” Data communication can be performed using hypertext transfer protocol (HTTP) or hypertext transfer protocol secure or hypertext secure sockets (both are referenced as HTTPS). In an additional implementation, extensible hypertext markup language (XHTML) is used to communicate or present information. The collection device and central authority may implement other standards, such as extensible markup language (xml), in conjunction with or separate from public key encryption (PKI) used to encrypt the data for communication or storage. In embodiments, the collection device and central resource communicate in a client-host arrangement.

As illustrated, for interactions involving the central resource 634 and various resources 660, 670, 680, the central resource 234 functions as a hub in a hub and spoke configuration with the resources 660, 670, 680 to support the central resource 634 that in-turn supports the touchpoints 614/local resource(s) 664. The resources including the biometric information resource 660, Advanced Passenger Information System (APIS) 670, and Airline Ticketing 680, and can include other collection devices, other systems (e.g., common carrier reservation/check-in systems), computer systems operated by governments or law enforcement, quasi-government organizations (National Center for Missing and Exploited Children), and so forth. The central resource 634 can function in a variety of ways depending on the corresponding system/device with which it is interacting or receiving communication. The central resource 634, for instance, is configured to receive information (as indicated by the arrows) from resources 660, 670, 680 or other common carrier systems, while it handles different tasks for collection devices 615, internal/local resources 664, and so on.

With focus on the central resource 634, the processor 610 for the central resource 634 includes a matching module 618. The matching module 618 represents functionality to accept information, generate records, match entry/exit records for individuals, verify information, and so forth. The matching module 618 can be comprised of computer executable instructions, e.g., a program or script, which are constructed to enable the processor to perform the described task.

The matching module 618 can be constructed to receive information from a variety of sources including, but not limited to collection devices 614, other systems, and so forth. For example, the central resource 634 is constructed to save biographic, biometric, and/or travel information in a record 612 of a database 615 in memory 616 for an individual for which a record does not exist. The foregoing occurs when, for instance, the individual is entering the country for the first time.

In other instances, a new record 612 is generated for an individual instance (e.g., each time an individual enters the country). Although biographic and biometric information may be associated with one another in a record 612, the matching module 618 can be configured to separate the information or otherwise arrange it to promote rapid searching based on a particular criterion or criteria or a design preference. For example, a record 612, to which the matching module 618 stores the information for an individual, includes a link that directs access to the biometric information stored in a corresponding biometric information record. See, e.g., record 240 of FIG. 2 and accompanying description above for additional information.

Those of skill in the art will appreciate that the functionality and corresponding hardware/software described in conjunction with the information modules 226, 444A can be included in the central resource 634 and/or the biometric information resource 660 for a substantially similar purpose and/or function in a substantially similar manner taking into account its incorporation in the central resource or biometric information resource as appropriate. For completeness, an information module 626A is illustrated in the central resource while 626B is illustrated in the biometric resource 660. Although the information module is illustrated as being within the matching module (in part for ease of understanding) it is to be appreciated that the various sub-modules forming the information module may be designed to be independent and one or more APIs used to permit the sub-modules to interact/communicate as desired based on design preference. Those of skill in the art will appreciate that the arrangement, function, and inclusion of one or more “sub-modules” such as the biometric, constraint, or linking modules as described in conjunction with the front end system and touchpoints can be included based on design preference with the respective module/sub-module functioning in accordance with the role associated with the device within which it is included or associated, e.g., a linking module included in the central resource functions as if it is a host or master (commensurate with the role of the central resource 634) rather than a client.

In implementations, the biometric resource functions as a dedicated or semi-dedicated resource for the central resource, a local resource/front end system, or one or more touchpoints if for example they are collectively performing the functions described in conjunction with the front end system or local resource (e.g., cloud resource). In this manner, the central resource can “off load” or instruct the biometric resource to perform tasks such as biometric matching, biometric exclusion, data storage, lockout, and so forth to the biometric resource 660 in favor of comparatively higher level management tasks. An example of the preceding is the central resource permitting the local resource to take control of the biometric resource to set a flag on a record in question, scan an in question image/hash against a gallery maintain by the biometric resource (e.g., biometric records 666), call out to a third party biometric data source (e.g., a data base of missing/exploited persons such as the one operated by the Center for Missing and Exploited Children), and so forth.

As should be appreciated, a touchpoint 614 may include a matching module (supported by hardware/software) to function in a manner as the matching module 618. One or more of a front end server, a local resource 664 (e.g., one or more servers in the predetermined or local area), or the touchpoints 614 can include a matching module that performs the same or similar functions to the matching module 618. In some embodiments, the local computing resource 604 and/or collection device 614 can perform matching or a portion thereof, such as preprocessing information for the central resource/matching module 618.

In some instances, a subset of the biometric information is retained in the record 612, e.g., a part of the biographic information or a computational result that is indicative of the biometric information, e.g., a biometric signature, a hash of the biometric information. In the foregoing example, the biometric module and/or the matching module 618 calculate the biometric signature based on collected biometric information, e.g., facial dimensions. A biometric signature can be used to promote rapid biometric matching such as for routine identification. In embodiments involving multiple records, they can be linked via a unique identifier, such as a passport number, a session identifier, an assigned number, or the like. In embodiments including a biometric resource, the biometric functionality may be supported by the biometric resource or the biometric resource can perform some tasks (e.g., storage, matching, exclusion) to free up the central resource's processing and/or memory resource. While the biometric resource 660 can perform such roles, it is to be apparent that some biometric information may still be handled by or retained on the central resource, e.g., the central resource handles hashes of biometric information while the biometric resource handles raw images, performs biometric matching and the like as contemplated by one of ordinary skill in the art. For example, the biometric resource may maintain a more detailed hash in comparison to that implemented by the central resource for use in situations where greater accuracy is requested.

For example, the database 615 and records 612 stored therein are structured to facilitate searching based on name, identifiable biographic information (e.g., eye color, tattoo description, hash). The foregoing can be done by segregating some information in a record 612 (e.g., in a name record or entry record) from other information (e.g., separating biometric information, such as the majority of an individual's biometric information, from remaining biographic information), duplicating some information in a table (e.g., a lookup table), indexing information, and so on to increase efficiency relative to a database without such a feature. Biometric information or portions thereof can be handled in similar manners. In embodiments, information associated with a particular trait or traits, e.g., eye spacing, is used to aid in rapid general identification or eliminating possible matches, while other identification techniques (other traits, combinations of traits, behaviors, etc.) are used to promote accurate identification by confirming an individual's identity.

In embodiments, the approaches, techniques, algorithms, implemented by the matching module 618 are tailored based on structure and/or operating parameters of the database 615. For example, the algorithm is configured to match an individual leaving with his/her entry record by matching information in a particular order. For instance, the matching module 618 implements an algorithm that matches entry records based on the country that issued the passport in order to reduce the records to be searched before searching for a particular passport number. In another instance, the algorithm uses a unique identifier (e.g., a machine readable barcode on a travel document) that points to a record to which a match is to be made. In the previous example, the matching module 618 attempts to make a match, e.g., match identities, based on the unique identifier before reviewing other records and/or lists or a database of individuals for which other procedures are to be employed. It is to be appreciate that biometric features may be similarly categorized to minimize the gallery used to perform a match or exclusion.

The matching module 618 can be configured to operate in a variety of modes that are accessed responsive to user input, e.g., a system manager configures the system to implement a higher accuracy level in comparison to standard operation or dynamically based on a variety of information factors. The central resource 634, for example, supports a GUI that is configured to accept user input to increase the matching module's certainty level, such as during a time of heightened security in comparison to normal operation. In the preceding instance to increase accuracy, the matching module 618 matches additional information to increase certainty. In other embodiments, different information or additional information can be used to increase certainty. For example, instead of performing a “standard” biometric match, that yields ninety-two percent (92%) certainty, the matching module 618 performs a more in-depth review that increases accuracy to ninety-eight percent (98%) by matching more factors, matching to a greater degree of accuracy, combinations thereof and so forth.

In other embodiments, the matching module 618 dynamically alters, such as via an algorithm, how and/or what algorithm is used to confirm a match. For example, if it appears based on biographic information that an individual is to be subject to additional procedures, e.g., additional safety screening, the algorithm implements additional checks to heighten certainty that the individual or his/her information does correspond to an individual warranting this type of treatment. The foregoing is done in comparison to a situation in which the individual is not associated with additional procedures. In additional embodiments, the matching module 618 is configured to alter how, what, and/or to what extent biometric information is used to identify an individual. For example, an algorithm used by the central resource 634 applies a higher facial recognition standard to an individual associated with poor fingerprint image, such as a brick layer.

Example heightened checks comprise additional information matching, the use of different or more rigorously applied biometric identification algorithms (in comparison to that commonly implemented by the central resource). For example, while the matching module 618 implements a target matching algorithm to identify an individual who is not to enter the country, an identification algorithm is used to verify the individual is indeed the individual who is barred from the country. In other examples, the matching module 618 dynamically lowers accuracy to a predetermined acceptable level in order to increase the number of individuals that can be screened.

In some instances, the matching module 618 coordinates information for a current instance with historical information. In some instances current information is married with historical information. In other instances, the matching module 618 uses historical information as a check or validation on current information. The matching module 618 can perform this check by comparing a particular piece of information (e.g., a unique identifier such as a passport number) or based on a combination of information. An example of the latter situation is combining a first or given name, a last or surname, with a date of birth, and/or other biographic information to determine what tasks to perform, e.g., obtain additional information, impose predefined procedures, deny access, and so on. The matching module 618 in addition to or in place of the foregoing can also check the data to determine it is valid, e.g., a birthdate is composed of a month, day, year in that order.

Other information can be stored in conjunction with at least some of the information (biographic, biometric, travel). For instance, the matching module 618 includes a unique identifier (e.g., a record identifier, a session identifier) with the information. The matching module 618 can include other information in the record as well. For example, the matching module 618 includes one or more of a time stamp, a software version, algorithm configuration, and the like with the information comprising the record 612. This other information can be included directly or used as metadata to biographic, biometric, or travel information.

Memory 616 can be used to store information in a variety of ways or formats. For example, information for an individual whether obtained from a collection device, received in a manifest 607, or obtained from another system/resource 660, 670, 680, can be stored in a record 612 that is generated when an individual enters or attempts to enter a country. In other examples, information is stored in a name record that contains information for (potentially) multiple instances. A name record for example may contain information for multiple visits, e.g., multiple entry/exits for a particular individual in addition to containing biographic information for the individual. Memory 616 can house other databases 615, e.g., a manifest 607 database configured to contain manifests 607 from common carriers. Memory 616 can house or contain other databases, tables (lookup tables) and so forth. For example, information for people meeting pre-specified criterion can be housed in a separate database or lookup table.

Other example databases 615 include a procedure database that details procedures, prompts, questions, additional information, and so on to be used. For example, the central resource 634 includes an information database that details common information associated a geographical area (e.g., a departure city, country, state). The central resource 634 may use this database 615 to formulate questions designed to test whether an individual is aware of information that is commonly known for an area.

In embodiments, the central resource 634 maintains information associated with certain characteristics in a database 615 for comparison against information for individuals. An example of the foregoing is the matching module 618, as part of receiving and/or storing information, uses a lookup table to determine whether information for an individual matches or at least partially matches that contained in the table. For example, the matching module 618 implements a script or other logic to determine whether the name of an individual is that of someone who is not permitted to use a particular form of transportation. In this example, not only may the lookup table include information on persons meeting a preselected criterion, but it can include colorable variations of the information. Example variations include alternative spellings, misspellings, aliases, date ranges such as for birthdates, variations in physical descriptors (e.g., brown for hazel eye color), combinations thereof, and so forth. While the forgoing checking has been described with respect to record creation, a substantially similar process may be used when matching information for an individual leaving with that of an entry record. Moreover, the matching module 618 can implement a matching algorithm, e.g., a graphical based algorithm, which accounts for variation in individual pieces of information.

Moreover, while the preceding processes are described in conjunction with storing information, in some instances information is stored in a record 612 and then compared to determine whether a match exists. For example, rather than delaying overall productivity, a server functioning as the central resources 634 temporarily stores information into the database 615 and then reviews it in parallel rather than checking and storing the information in series.

In embodiments, the central resource 634, e.g., the matching module 618, validates information to ensure it is properly formatted (e.g., the information is valid), conducts an initial review of the information, or a combination thereof. In embodiments, the central resource 634 can perform validation, consistency checking, and/or constraint checking as described above with reference to FIGS. 5A-5C. In an embodiment, the matching module 618 checks the information to determine whether it duplicates previously submitted information. The foregoing can be done by querying the database 615 based on one or more portions of the information. For example, it may check a passport number against those in the system to identify someone attempting to use an altered passport, i.e., the passport has a valid passport number but the contained information is not accurate to the information upon which the passport was issued. Although validation is described in conjunction with the matching module 618 in other instances the validation and/or initial review functionality is embodied as a validation module (e.g., such as the various validation modules shown in FIGS. 5A-5C). Such a validation module is representative of functionality to validate information and supported by a program of instructions, e.g., implementation of a set of validation rules by the matching module. For instance the central resource 634 includes a validation script that executes to perform validation logic. Validation or initial review can be performed in a distributed manner, e.g., a collection device such as a mobile device and/or touchpoint 614 performs a portion of the task and the central resource 634 performs other portions or confirms the validation or review.

The central resource 634 and matching module 618 can be configured to perform additional tasks. For example, periodically or upon request the central resource 634 is configured to check whether individuals corresponding to records 612 in a database 615 meet a predetermined criterion, e.g., overstayed his/her visa. In instances like this, the matching module 618 or another component of the central resource 634 check records 612 containing information meeting the criterion, e.g., “overstay.” In response, the central resource 634 creates or updates a database 615 with information from records 612 that meet the criteria and/or creates/updates a table or other data structure with links to records that meet the criterion. The central resource 634 can add information to the record 612 to indicate the record 612 meets the criteria. For example, in addition to populating an overstay database 615 with information for people who overstayed his/her visa the matching module 618 may flag the records 612 by including information in the record that shows the individual has overstayed.

The various resources 660, 670, and 680 are shown to include similar features described above with reference to the central resource 634, with corresponding similar functionality and capability. For example, the biometric information resource 660 includes processor 661, communication unit 662, memory 663, database(s) 665, and (biometric) records 666. The APIS 670 includes processor 671, communication unit 672, memory 673, database(s) 675, and manifest 676. The airline ticketing resource 680 includes processor 681, communication unit 682, memory 683, database(s) 685, and ticketing records 686.

The various resources 660, 670, and 680 are shown specifically in FIG. 6, However, while a variety of devices, components, examples, and scenarios are described, multiple devices and components can be used and the various tasks handled among the components in a distributive manner, e.g., dividing up tasks, allocating user devices, and the like among the physical computing devices comprising the intermediate. Although but one collection device touchpoint 614 and central resource 634 are illustrated for simplicity, the system can include multiple devices and components with similar functionality or functionality that differs to permit that device/component to perform a particular task or role as described herein. It is to be appreciated for example, multiple components of similar type can be included. For example, a collection device includes an image capture device for fingerprints and another for iris scanning.

It should be noted that while various structures and functions are described with respect to certain members within the environment, the functions and/or structures may be implemented by other members in the environment, e.g., the central resource 634 includes a validation module (such as that described with respect to FIGS. 5A-5C), even though not specifically illustrated in FIG. 6. For example, a collection device touchpoint 614 includes a matching module to identify an individual. For example, instead of the central resource 634 matching an individual, matching is performed by the collection device touchpoint 614 and/or a computing system front end 604 operated in a local environment 664, e.g., a server at the departure airport. In scenario such as this, the central resource 634 can preposition information in the local environment 664 for use in matching. In some examples, the central resource 634 prepositions biographic and biometric information associated with a traveler who is scheduled to depart the local environment.

As illustrated schematically through the use of arrows, the central resource 634 can preposition information collected from various other resources into the central resource 634, such as from the illustrated biometric information resource 660 (to preposition its biometric records 666), from the illustrated APIS 670 (to preposition its manifest 676), and from the airline ticketing 680 (to preposition its ticketing records 686). Such prepositioning can be accomplished at predetermined times to avoid surges, such as during late/early hours of typically low activity where bandwidth and server resources are not otherwise in high demand. In the illustrated example of FIG. 6, the central resource 634 has prepositioned a copy of manifest information 607 to the database 615 of the central resource 634, which was obtained from the manifest 676 of the APIS 670. Other information, such as biometric records 666, ticketing records 686, and the like can be obtained by the central resource 634 from other resources.

Prepositioning can be done at various times, such as on a routine basis (e.g., 24 (twenty-four) hours ahead), a periods of low processing and/or low communication (e.g., overnight). Prepositioning of information may occur at discrete times. For example, biographic information and a hash of a facial image are sent at one time while an image of the individual is sent at another time. The foregoing may be done based on a variety of factors, such as data size, based on a predictive factor (inclement weather is forecast, and so on).

Processing, such as the matching module 618 identifying a match at a local level, can occur on a local computing resource 604, 664 or on the collection device 614 itself. For example, as will be described in additional detail below, the prepositioned information may be in a generic form so it is agnostic of one or more of the device, software, or algorithm used to capture or process the data, such as a biometric signature, e.g., positions of key facial features. In some examples, the data is agnostic of proprietary algorithms and/or data formats. In other instances, the matching module in the collection device 614 performs biometric matching in a proprietary format using generic data. If for example, the collection device 614 determines a facial hash is corrupt, it may retrieve the underlying facial image from a local server 604 or the central resource 634, and apply its algorithm to the historic image in order to attempt to make a match with an image captured contemporaneously from an individual being screened.

In some instances, a common carrier or a local environment, such as an airport authority or port authority, provides to and/or responds to requests for information to/from the central resource 634. A variety of information sources can provide additional and/or revised information for storage/processing by the central resource 634, whether initial or otherwise. Manifests and updates to manifest information may be provided by the APIS 670, and/or requested by the central resource 634, at various predetermined times prior to departure to permit efficient processing and/or communication of at least some of the information in the manifest. Information received and/or requested by the central resource 634 can include additional or revised information, including deleted or canceled information to a manifest 676, such as a most recent in time manifest 607. A common carrier may provide information such as this on an ad hoc or a scheduled basis, to account for changes that occur after a manifest 676 is requested and/or sent, whether an initial, interim, or final manifest 676. Ad hoc communications can be sent based on dynamic timing. An example of the foregoing is a common carrier responsive to an indication that the central resource 634 has available processing and/or communication resources.

In an embodiment, the manifest information and as applicable additional or revised data is combined to prepopulate to a local environment 664. While an initial list may represent all, substantially all, or a significant portion (e.g., by data size or data type such as biographic information) of the biographic/biometric information that is to be provided to a local environment, in other instances it may be a portion of the information. The initial list may include for example some biographic information with all, substantially all, or a significant portion (e.g., by data size) of the biometric information to be provided for matching individuals.

In embodiments, the initial list is prepositioned for use in a local environment prior to anticipated usage. For example, the central resource 634 communicates at least some biographic information, biometric information, or combinations thereof to a local environment 664. In the previous example, the local environment 664 can be a computing resource, such as one or more servers 604 that support for example a destination airport. The initial list may include the available biometric information, biographic information, or a combination thereof of information that is available for individuals arriving for a given time period, a particular flight, or the like. For example, the list includes the biometric and relevant biographic information for passengers on a cruise ship. Example biometric information may include one or more of a historic image (e.g., passport photo), biometric facial measurements, an image of a traveler's fingerprint, information from a retina scan, and so on that can be used to bio-identify an individual.

In some embodiments, a list may also include instructions for the local resource (e.g., server, collection device) to follow. For example, the central resource, via the list, can instruct a collection device to implement a higher bio-matching threshold, collect additional biometric information (e.g., capture all finger prints, a palm print), ask for biographic information, require additional screening, check for contraband, and so forth.

In embodiments, an initial list may be communicated at various points in time prior to departure. For example, the central resource 634 may send the initial list 24 (twenty-four) hours prior, approximately 24 (twenty-four) hours prior, or based on one or more of processing resource or communication link availability at or near a predetermined time. In an additional example, an initial list is processed 24 (twenty-four) hours prior to departure, but the information is not communicated until 20 (twenty) hours prior to departure to avoid overwhelming communication links, local resources, based on another priority (e.g., number of individuals on a flight), or combinations thereof

Prepositioning information, such as by communicating and receiving an initial list to a local environment can result in the information being populated to memory associated with a local environment 664. For instance, information included in the initial list is used to populate a local database that supports a particular airport or collection of airports. This permits the system to position information based on allocable system resources. The foregoing may speed local processing/identification as communication and central processing delays are avoided.

A dataset including biographic and/or biometric information, such as from resources 660, 670, 680, can be used by the central resource 634 and/or local resource(s) 664 in matching an individual. Building a data set may occur similar to assembling information associated with an individual during routine information handling. This can include encrypting and/or packetizing the data for communication.

In some embodiments, the request and/or information to be provided is subject to various processes (e.g., validation, integrity checks) as part of the dataset build process, such as the various processes described in FIGS. 5A-5C and throughout the present disclosure. In some instances, the dataset build process implements additional procedures based on a variety of factors. Example factors include, but are not limited to, type of travel, time to anticipated departure, departure location, destination location, and factors associated with other individuals traveling on the vehicle.

In an embodiment, the encrypted and packetized dataset is communicated to the local environment 664, e.g., a server 604 supporting a departure airport. The communication can occur at a predetermined time, based on the prioritization established when the expedited request was received, as resources are available, on a first-in-first-out basis, or based on other factors, such as local resources, security parameters, travel plans of the individual or vehicle on which the individual is to travel, potential disruption to a common carrier, or the like.

The information in the expedited dataset can be used to populate a database in a local environment 664. For example, the information is used by the local server 604 to build a name record that generally mirrors that of the central resource 634. It should be appreciated that the record on the local resource 664, 604 may not include the extent of information that is stored in memory in association with the central resource 634. For example, the central resource 634 may include additional biographic information, like information associated with a previous trip taken by the individual.

Additionally, for example, the local resource 664, 604 accepts changes to biometric and/or biographic information that is promulgated back to the central resource 634 at a predetermined time or on the occurrence of an event, e.g., availability of resources. For example, in response to an individual's address change, but whose information otherwise meets a predetermined threshold, the updated information is communicated to the central resource 634 for inclusion in the database. In another example, an individual's facial image or facial recognition information is automatically added to the record 612 of the central resource 634 to better identify a passport held as he/she ages for the period of time his/her passport is valid. In this way, so long as a child/young adult makes use of a system employing the method his/her passport life may be extended with the provision that entry/exit is limited to times when updated images or facial recognition information is available to the system.

In embodiments, central resource 634 and/or a local resource 664, 604 (a local server, collection devices, etc.) can set a flag on, for example, a name record including one or more of biometric or biographic information for a specific individual. For example, the central resource 634 sets a flag on a record 612 that is being released (e.g., used) to a local resource 664, 604. In this manner, until the local resource 664, 604 releases the flag (or the central resource 634 does so on its behalf, e.g., if no other local resources can make use of the name record). Thus, if for some reason the local resource 664, 604 loses communication with the central resource 634, the system (via the flag) ensures that record 612 cannot be reused while communication is broken. The local resource 664, 604 that set the flag can use the information included in the initial list from the name record to match an individual to his/her information as reflected in the name record 612 on the central resource 634. Such a decision may be a provisional decision that is ratified once communication is reestablished with the central resource 634. The local 664, 604 and central resource 634 can reconcile their information once communication is restored or thereafter based factors including priority, communication and processing resources, and the like.

In other instances, upon a lapse in communication between the central resource 634 and a local resource 664, 604 that has been populated with information, the local resource 664, 604 (server, collection device, and so on) is prevented from matching an individual until communication is reestablished or may be permitted to do so provisionally.

The central resource can generate a final database 615 that includes information from the various resources and comparison processes. The final database 615 may identify information for the individuals that are traveling on a particular vehicle, a flight. In some embodiments, in addition to identifying those individuals that boarded, the final database 615 can include a manifest 607 that includes, or the information generated during screening is otherwise associated with, the manifest 607 and/or an individual associated with the manifest 607. For example, facial recognition information for a lap infant is associated with the individual with whom the infant is traveling, e.g., the parent or legal guardian. Thus, relational information from screening and/or the mode of travel (flight) can be associated with the individual. An example of the latter information is information that associated an individual with screening or travel information that is not directly associated with the individual himself or herself. In the illustrated embodiment, the final database 615, or a subcomponent/data thereof, is sent to the central resource 634 as part of closing out the transaction with the central resource 634. The central resource 634 can release the flag as part of this or responsive successful closeout.

The networks 110, 210, 664, as illustrated throughout the drawings and described in other locations throughout this disclosure, can comprise any suitable type of network such as the Internet or a wide variety of other types of networks and combinations thereof. For example, the network 210 may include a wide area network (WAN), a local area network (LAN), a wireless network, an intranet, the Internet, a combination thereof, and so on. Further, although a single network is shown in FIG. 1 (or in other figures), the network 110 may be configured to include multiple networks.

Computer storage media and/or memory includes volatile and non-volatile, removable and non-removable media and memory implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a mobile device, computer, server, and so forth. For example, instructions embodying an application or program are included in one or more computer-readable storage media, such as tangible media, that store the instructions in a non-transitory manner.

Various techniques are described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media.”

### CONCLUSION

Certain attributes, functions, steps of methods, or sub-steps of methods described herein are associate with physical structures or components, such as a module of a physical device, that in implementations in accordance with this disclosure make use of instructions (e.g., computer executable instructions) that are embodied in hardware, such as an application specific integrated circuit, computer-readable instructions that cause a computer (e.g., a general-purpose computer) executing the instructions to have defined characteristics, a combination of hardware and software such as processor implementing firmware, software, and so forth such as to function as a special purpose computer with the ascribed characteristics.

For example, in embodiments a module comprises a functional hardware unit (such as a self-contained hardware or software or a combination thereof) designed to interface the other components of a system. In embodiments, a module is structured to perform a function or set of functions, such as in accordance with a described algorithm. That this disclosure implements nomenclature that associates a particular component or module with a function, purpose, step or sub-step is used to identify the structure, which in instances includes hardware and/or software that function for a specific purpose. Invocation of 35 U.S.C. § 112(f) will be accomplished through use of ubiquitous and historically-recognized terminology for this purpose. The structure corresponding to the recited function being understood to be the structure corresponding to that function and the equivalents thereof permitted to the fullest extent of this written description, which includes the accompanying claims and the drawings as interpreted by one of skill in the art.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. Although headings are used for the convenience of the reader, these are not be taken as limiting or restricting the systems, techniques, approaches, methods, devices to those appearing in any particular section. Rather, the teachings and disclosures herein can be combined, rearranged, with other portions of this disclosure and the knowledge of one of ordinary skill in the art. It is the intention of this disclosure to encompass and include such variation.

What is claimed is:

1. One or more tangible computer-readable storage media embodying computer-readable instructions which are executable by a computing system to:
merge information and biometric information responsive to receipt of linking information from at least one of a trusted device or an untrusted device, the merged information being stored in a record of a transaction, the linking information being obtained from the other of the trusted device or untrusted device by the at least one of the trusted device or the untrusted device;
generate an electronic receipt for the transaction, the electronic receipt including machine readable information usable by the computing system to retrieve at least a portion of the merged information from the record; and
retrieve the at least a portion of the merged information responsive to reading the machine readable information output on the untrusted device.

2. One or more tangible computer-readable storage media of claim 1, wherein the linking information comprises at least one of: machine readable information that identifies the trusted device; machine readable information that identifies a biometric information capture event associated with generation of the biometric information; or a hash of one or more of: at least a portion of the information, an identifier for the trusted device, a timestamp for the capture event, an identifier associated with the capture event, or at least a portion of the biometric information.

3. One or more tangible computer-readable storage media of claim 2, wherein the computer-readable instructions are further configured to cause the computing system to store the merged information subsequent to generation of the electronic receipt.

4. One or more tangible computer-readable storage media of claim 3, the computer-readable instructions being further configured to cause the computing system to obtain a unique identifier for the untrusted device in addition to the linking information and store the unique identifier in the record.

5. One or more tangible computer-readable storage media of claim 4, wherein the unique identifier comprises a mobile subscriber identity identifier associated with a subscriber identity module (SIM) card.

6. One or more tangible computer-readable storage media of claim 4, wherein the computer-readable instructions are further configured to cause the computing system to communicate the machine readable information responsive to determination that the unique identifier has been presented during establishment of communication.

7. One or more tangible computer-readable storage media of claim 4, wherein the computer-readable instructions are further configured to cause the computing system to:
modify the record with information associated with a predetermined criterion, the record being accessed responsive to reading the machine readable information; and
update the untrusted device with human understandable directions that are different from human understandable directions originally provided with the machine readable information.

8. One or more tangible computer-readable storage media of claim 7, wherein the human understandable directions are provided in a text message that is associated with the computing system and the machine readable information.

9. One or more tangible computer-readable storage media of claim 1, wherein linking information comprises a two-dimensional barcode that at least one of identifies the trusted device or is unique to an anticipated capture event with which the biometric information is associated.

10. One or more tangible computer-readable storage media of claim 1, wherein the two-dimensional barcode comprises at least one of an encrypted version of at least a portion of the information or identification of a location in memory associated with the computing system where the information is stored.

11. One or more tangible computer-readable storage media of claim 1, further comprising computer-readable instructions which are executable by the computing system to:
determine whether the untrusted device is within a predetermined geographic location; and
communicate the electronic receipt to the untrusted device responsive to a determination that the untrusted device is within the predetermined geographic location.

12. One or more tangible computer-readable storage media of claim 11, wherein the geographic area comprises a port-of-entry.

13. One or more tangible computer-readable storage media of claim 11, wherein the determination is based on at least one of: a global positioning system (GPS) signal, a beacon signal, a Bluetooth signal, a wireless local area network signal, and a cellular network signal.

14. One or more tangible computer-readable storage media of claim 1, wherein the machine readable information comprises a two-dimensional barcode.

15. One or more tangible computer-readable storage media of claim 1, wherein the machine readable information comprises a unique identifier for the untrusted device.

16. One or more tangible computer-readable storage media of claim 15, further comprising computer-readable instructions which are executable by the computing system to interrogate a device used to present the machine readable information to determine whether the device is associated with the unique identifier contemporaneous with the machine readable information being obtained by the computing system.

17. One or more tangible computer-readable storage media of claim 16, further comprising computer-readable instructions which are executable by a computing system to generate an alert if the device used to present the machine readable information is not associated with the unique identifier.

18. A method comprising:
responsive to a determination that an untrusted device is within a predetermined physical location, accepting information from the untrusted device;
merging, using machine readable information associated with a trusted device received from the untrusted device, biometric information from the trusted device with information from the untrusted device; and
communicating to the untrusted device an electronic receipt including machine readable information usable by a computing system performing the method to retrieve at least a portion of the merged information responsive to reading of the machine readable information in the electronic receipt.

19. The method of claim 18, wherein the machine readable information from the untrusted device identifies: the trusted device, a biometric information capture event associated with generation of the biometric information, a timestamp for the capture event, or an identifier associated with the capture event.

20. The method of claim 18, further comprising checking an identifier received during a handshake between the computing system and an untrusted device attempting to receive the electronic receipt with an identifier received with the information from the untrusted device to determine that the untrusted device attempting to receive the electronic receipt is the untrusted device.

21. The method of claim 20, wherein the identifier received with the information from the untrusted device comprises a mobile subscriber identity identifier associated with a subscriber identity module (SIM) card.
